(19) United States
(12) Patent Application Publication
(10) Pub. No.: US 2009/0130366 A1
(43) Pub. Date: May 21, 2009

(54) Optical Information-Recording Medium and Information-Recording Method

(75) Inventors: Keita Takahashi, Kanagawa (JP); Tetsuya Watanabe, Kanagawa (JP); Kazutoshi Katayama, Kanagawa (JP)

Correspondence Address: TAIYO CORPORATION, 401 HOLLAND LANE, #407, ALEXANDRIA, VA, 22314, US

(73) Assignee: Fujifilm Corporation, Tokyo (JP)

(21) Appl. No.: 11/887,230

(22) PCT Filed: Jun. 29, 2006
(86) PCT No.: PCT/JP2006/313438

§ 371 Date: Sep. 27, 2007

(30) Foreign Application Priority Data
Jun. 29, 2005 (JP) 2005 190319
Mar. 15, 2006 (JP) 2006 071707

(51) Int. Cl. B32B 3/02

(52) U.S. Cl. 428/64.8

(57) ABSTRACT

There is provided an optical information-recording medium, comprising a recording layer capable of recording of information by irradiation of a laser beam having a wavelength of 440 nm or less on or above a substrate, the recording layer comprising a dye having two or more independent dye moieties in the molecule that are bound to each other in a manner other than by forming a conjugated bond to the dye moieties, and a method of recording information, comprising recording information by irradiating a laser beam having a wavelength of 440 nm or less on or above the optical information-recording medium according to the present invention described above.

### CROSS-REFERENCE TO RELATED APPLICATION

The disclosures of Japanese Patent Application Nos. 2006-071707, 2005-190319 are incorporated herein by reference in its entirety.

### TECHNICAL FIELD

The present invention relates to an optical information-recording medium, and a method of recording information, allowing recording and reproduction of information by using a laser beam. The invention in particular relates to a heat-mode optical information-recording medium and an information-recording method suitable for information recording by using a laser beam having a wavelength of 440 nm or less.

Optical information recording media (optical disks) where information is recorded only once by laser beam irradiation are known. Such optical disks, often called write-once CD's (so-called CD-R), have a typical structure wherein a recording layer containing an organic dye, a light-reflectance layer of a metal such as gold, and a resin protective layer are formed on a transparent disk-shaped substrate in that order. Information is recorded on a CD-R by irradiation of a laser beam in the near-infrared region onto the CD-R (normally, laser beam at a wavelength of around 780 nm). In the irradiated area of the recording layer light is absorbed, there is a resulting localized increase in temperature, and this changes its physical and chemical properties (e.g., pit generation). Because of these physical and chemical changes the optical properties are changed and information can be recorded. Reading of the information (reproduction) is also carried out by irradiating with a laser beam having a wavelength the same as that of the recording laser beam. Information is reproduced by detecting the difference in reflectance between areas where the optical properties of the recording layer have been changed (recorded area) and areas where they are not changed (unrecorded area).

Recently, networks such as Internet and high-definition TV's are rapidly becoming more and more popular. HDTV (High-Definition Television) broadcasting has also resulted in increased need for a large-capacity recording medium for recording image information more cost-effectively. The CD-R's described above, and write-once digital-versatile-disks (so-called DVD-R's) allowing high-density recording by using a visible laser beam (630 to 680 nm), have established themselves as large-capacity recording media to some extent, but still, do not have a recording capacity large enough to cope with future requirement. Optical disks having higher recording density and larger recording capacity, and that use a laser beam having a wavelength shorter than that for DVD-R's have been studied, and, for example, a photorecording disk in the so-called “Blu-ray mode” that uses a blue laser having a wavelength of 405 nm has been commercialized.

The methods for recording information on and playing back information from optical recording media including an organic dye recording layer by irradiating the recording layer with a laser having a wavelength of 530 nm or less are disclosed. These methods specifically propose irradiating, with a blue (wavelength of 430 nm or 488 nm) or blue-green laser (wavelength of 515 nm) laser, optical disks including a recording layer comprising a dye such as a porphyrin compound, an azo dye, a metallic azo dye, a quinophthalone dye, a trimethynecyanine dye, a dicyanovinylphenyl skeleton dye, a coumalin compound, phthalocyanine compound, and a naphthalocyanine compound. In addition, methods for recording information on and playing back information by irradiating the optical disk having a recording layer including oxonol dye with a laser having a wavelength of 550 nm or less are disclosed. See e.g. Japanese Patent Application Laid-Open (JP-A) Nos. 2001-287460, 2001-287465, 2001-253171, 2001-39034, 2000-318313, 2000-318312, 2000-280621, 2000-280620, 2000-263939, 2000-222772, 2000-222771, 2000-218940, 2000-158818, 2000-149320, 2000-108513, 2000-113504, 2002-301870 and 2001-287465, U.S. Pat. No. 2002-76648A1, JP-A Nos. 2003-94828 and 2001-71638.

However, according to the studies by the inventor, the optical disks using a known dye are still not at a level satisfies the requirements regarding recording properties. In addition, optical disks using one of the oxonol dyes disclosed in JP-A No. 2001-71638 are still unsatisfactory in practice, because the oxonol dyes used in the patent application are lower in optical storability. Alternatively, the oxonol dyes described in JP-A No. 2004-188968 are sufficient in optical storability, but there are no dyes described therein that allowed information recording by using a laser having a wavelength of 440 nm or less.

### DISCLOSURE OF INVENTION

The present invention has been made in view of the above circumstance and provides an optical information-recording medium and a method of recording information.

A first aspect of the present invention provides an optical information-recording medium, comprising a recording layer capable of recording of information by irradiation of a laser beam having a wavelength of 440 nm or less provided on or above a substrate, wherein the recording layer comprising a dye having two or more independent dye moieties in a molecule that are bound to each other in a manner other than by forming a conjugated bond with the dye moieties.

A second aspect of the present invention provides a method of recording information by irradiating a laser beam having a wavelength of 440 nm or less onto the optical information-recording medium according to the first aspect.

### BEST MODE FOR CARRYING OUT THE INVENTION

(1) Optical Information-Recording Medium

The optical information-recording medium according to the present invention is an optical information-recording medium having a recording layer capable of recording of information by irradiation of a laser beam having a wavelength of 440 nm or less provided on or above a substrate, wherein the recording layer contains a dye having two or more independent dye moieties in the molecule that are bound to each other in a manner other than by forming a conjugated bond with the dye moieties. The dye moiety represents a group having a dye structure from which a hydrogen atom is eliminated and that is capable of binding to another compound.

Hereinafter, the optical information-recording medium according to the invention will be described in detail. When a particular portion is called a “group” in the invention, the group may be or may not be substituted with one or more substituent groups (up to the maximum possible) unless specified otherwise.

For example, an “alkyl group” means a substituted or unsubstituted alkyl group. In addition, the substituent group on the compound of the invention may be any substituent group, independent of where it is additionally substituted. Further, when a particular region is called a “ring”, or when the “group” contains a “ring” in the invention, the ring may be a monocyclic or fused ring and may be substituted or unsubstituted, unless specified otherwise. For example, an “aryl group” may be a phenyl or naphthyl group, or a substituted phenyl group.

The dye above preferably has a structure represented by the following Formula (I). In the following Formula (I), Dye¹¹, Dye¹², and Dye^{2k} each independently represent a dye moiety. The dye moiety represented by Dye¹¹, Dye¹², or Dye^{2k} is not particularly limited, and examples thereof include moieties such as of cyanine dye, styryl dye, merocyanine dye, phthalocyanine dye, oxonol dye, azo dye, azomethine dye, squalium dye, and metal chelate complex dye. The dye moiety represented by Dye¹¹, Dye¹², or Dye^{2k} is particularly preferably a moiety of a cyanine dye, merocyanine dye, oxonol dye, phthalocyanine dye, or metal chelate dye. The dye moiety represented by Dye¹¹, Dye¹², or Dye^{2k} is more preferably a moiety of a cyanine dye, merocyanine dye, or oxonol dye, and most preferably a moiety of a cyanine dye or oxonol dye. The dye moieties represented by Dye¹¹, Dye¹², and Dye^{2k} may be the same as or different from each other, but are preferably the same as each other. L¹¹ and L^{2k} each represent a bivalent connecting group that does not form a n-conjugated bond with the dye moiety bound thereto; n is an integer of 0 to 10; k is an integer of 0 to n; Q represents an ion for neutralizing the electric charge; and y is the number of the ions need for neutralizing the electric charge.

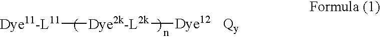

When the dye moiety represented by Dye¹¹, Dye¹² or Dye^{2k} is a cyanine dye moiety, the cyanine dye is preferably a cyanine dye represented by the following Formula (2).

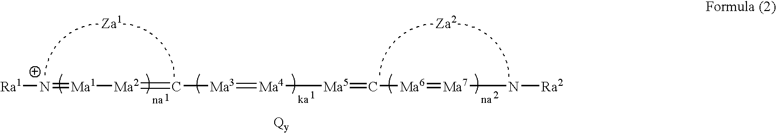

In Formula (2), Za¹ and Za² each represent an atom group forming a five- or six-membered nitrogen-containing heterocyclic ring that may be fused with a benzene ring, benzofuran ring, pyridine ring, pyrrole ring, indole ring, or thiophene ring, or the like.

R^{a1} and R^{a2} each represent a hydrogen atom, a substituted or unsubstituted alkyl group (preferably having 1 to 20 carbon atoms, such as methyl, ethyl, n-propyl, isopropyl, n-butyl, n-pentyl, benzyl, 3-sulfopropyl, 4-sulfobutyl, 3-methyl-3-sulfopropyl, 2′-sulfo benzyl, carboxymethyl, or 5-carboxypentyl), a substituted or unsubstituted alkenyl group (preferably having 2 to 20 carbon atoms, such as vinyl, or allyl), a substituted or unsubstituted aryl group (preferably having 6 to 20 carbon atoms, such as phenyl, 2-chlorophenyl, 4-methoxyphenyl, 3-methylphenyl, or 1-naphthyl),

a substituted or unsubstituted heterocyclic group (preferably having 1 to 20 carbon atoms, such as pyridyl, thienyl, furyl, thiazolyl, imidazolyl, pyrazolyl, pyrrolidino, piperidino, or morpholino); preferably a hydrogen atom, a substituted or unsubstituted alkyl group, or a substituted or unsubstituted sulfo alkyl group; and more preferably a substituted or unsubstituted alkyl group or a substituted or unsubstituted sulfo alkyl group. Ma¹ to Ma⁷ each independently represent a methine group that may be substituted, and favorable examples of the substituent groups include alkyl groups having 1 to 20 carbon atoms (such as methyl, ethyl, and i-propyl), halogen atoms (such as chlorine, bromine, iodine, and fluorine), a nitro group, alkoxy groups having 1 to 20 carbon atoms (such as methoxy and ethoxy), aryl groups having 6 to 26 carbon atoms (such as phenyl and 2-naphthyl), heterocyclic groups having 0 to 20 carbon atoms (such as 2-pyridyl and 3-pyridyl), aryloxy groups having 6 to 20 carbon atoms (such as phenoxy, 1-naphthoxy and 2-naphthoxy), acylamino groups having 1 to 20 carbon atoms (such as acetylamino and benzoylamino), carbamoyl groups having 1 to 20 carbon atoms (such as N,N-dimethylcarbamoyl), a sulfo group, a hydroxy group, a carboxy group, alkylthio groups having 1 to 20 carbon atoms (such as methylthio), a cyano group, and the like. The group may bind to another methine group forming a ring or bind to an auxochrome forming a ring.

Each of Ma¹ to Ma⁷ is preferably a unsubstituted, ethyl-substituted, or methyl-substituted methine group. na¹ and na² are 0 or 1 and preferably 0. ka¹ is an integer of 0 to 3, preferably an integer of 0 to 2, and more preferably 0. When ka¹ is 2 or more, Ma³ and Ma⁴ may be the same as or different from each other. Q represents an ion for neutralizing the electric charge; and y is the number of the ions need for neutralizing the electric charge.

In Formula (2), any one of Za¹, Za², Ra¹, Ra² and Ma¹ to Ma⁷ may bind to the connecting group L¹¹ or L^{2k} forming the dye moiety of Formula (I) with its hydrogen atom removed.

When the dye moiety represented by Dye¹¹, Dye¹², or Dye^{2k} is a merocyanine dye moiety, the merocyanine dye is preferably a merocyanine dye represented by the following Formula (3).

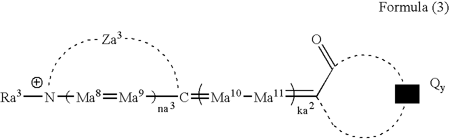

In Formula (3), Za³ represents an atom group forming a five- or six-membered nitrogen-containing heterocyclic ring that may be fused with a benzene ring, benzofuran ring, pyridine ring, pyrrole ring, indole ring, or thiophene ring, or the like. Za⁴ represents an atom group forming an acidic nucleus. Ra³ represents a hydrogen atom, a substituted or unsubstituted alkyl group, a substituted or unsubstituted alkenyl group, a substituted or unsubstituted aryl group, a substituted or unsubstituted heterocyclic group (favorable examples thereof are the same as those for Ra¹ and Ra²). Ma⁸ to Ma¹¹ each independently represent a methine group (favorable examples thereof are the same as those for Ma¹ to Ma⁷). na³ is 0 or 1. ka² is an integer of 0 to 3 and preferably an integer of 0 to 2. Q represents an ion for neutralizing the electric charge; and y is the number of the ions need for neutralizing the electric charge. When ka² is 2 or more, Ma¹⁰ and Ma¹¹ may be the same as or different from each other. In Formula (3), any one of Za³, Za⁴, Ra³, and Ma⁸ to Ma¹¹ may bind to the connecting group L¹¹ or L^{2k} forming the dye moiety of Formula (I) with its hydrogen atom removed.

The dye moiety represented by Dye¹¹, Dye¹², or Dye^{2k}, when it is an oxonol dye moiety, will be described below. The oxonol dye according to the invention is defined as a polymethine dye having an anionic dye. An oxonol dye represented by the following Formula (I) is used particularly favorably, form the viewpoint of recording properties.

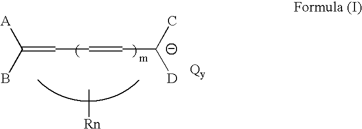

In Formula (I), each of A, B, C and D represents an electron-withdrawing group; “A and B” or “C and D” may bind to each other forming a ring; and the total Hammett σp value of the groups A and B and that of the group C and D are respectively 0.6 or more, when the groups do not bind to each other. R represents a substituent group on the methine carbon; m is an integer of 0 to 3; n is an integer of 0 to 2m+1; when n is an integer of 2 or more, multiple groups R may be the same as or different from each other, or may bind to each other forming a ring; Q represents an ion for neutralizing the electric charge; and y is the number of the ions need for neutralizing the electric charge.

The compound represented by Formula (I) includes multiple tautomers different in the notation of anion localization site, and the compound is usually expressed by placing the anionic charge on its oxygen atom, especially when any one of A, B, C, and D is represented by —CO-E (E represents a substituent group). For example when D is —CO-E, the compound is commonly expressed by the following Formula (II), and the compound in the Formula (II) is also included in the compounds of Formula (I).

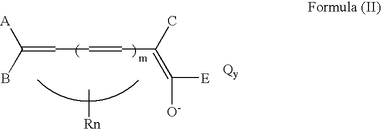

The definitions of A, B, C, R, m, n, Q, and y in Formula (II) above are the same as those in Formula (I).

Hereinafter, the oxonol dye represented by Formula (I) above will be described. In Formula (I), each of A, B, C and D represents an electron-withdrawing group; A and B or C and D may bind to each other forming a ring; and the total Hammett up value of the groups A and B and that of the group C and D are respectively 0.6 or more, when the groups do not bind to each other. A, B, C and D may be the same as or different from each other. The Hammett substituent constant σp value of the electron-withdrawing group represented by A, B, C or D is preferably, independently in the range of 0.30 to 0.85 and more preferably in the range of 0.35 to 0.80.

The Hammett substituent constants op value (hereinafter, referred to as σp values) are described, for example, in Chem. Rev. 91, 165 (1991) and the reference literatures therein, and those not described therein can be estimated according to the method described therein. When A and B (or C and D) bind to each other forming a ring, the σp value of A (C) means the σp value of -A-B—H(—C-D-H) group, while the σp value of B (D) means the σp value of —B-A-H (-D-C—H) group. In such a case, the σp values are different from each other, because the direction of the bond between the two is different.

Typical favorable examples of the electron-withdrawing groups include a cyano group, a nitro group, acyl groups having 1 to 10 carbon atoms (such as acetyl, propionyl, butyryl, pivaloyl, and benzoyl), alkoxycarbonyl groups having 2 to 12 carbon atoms (such as methoxycarbonyl, ethoxycarbonyl, isopropoxycarbonyl, butoxycarbonyl, and decyloxycarbonyl), aryloxycarbonyl groups having 7 to 11 carbon atoms (such as phenoxycarbonyl), carbamoyl groups having 1 to 10 carbon atoms (such as methylcarbamoyl, ethylcarbamoyl, and pheylcarbamoyl), alkylsulfonyl groups having 1 to 10 carbon atoms (such as methanesulfonyl), arylsulfonyl groups having 6 to 10 carbon atoms (such as benzenesulfonyl), alkoxysulfonyl groups having 1 to 10 carbon atoms (such as methoxysulfonyl), sulfamoyl groups having 1 to 10 carbon atoms (such as ethylsulfamoyl and phenylsulfamoyl), alkylsulfinyl groups having 1 to 10 carbon atoms (such as methanesulfinyl and ethanesulfinyl), arylsulfinyl groups having 6 to 10 carbon atoms (such as benzenesulfinyl), alkylsulfenyl groups having 1 to 10 carbon atoms (such as methanesulfenyl and ethanesulfenyl), arylsulfenyl groups having 6 to 10 carbon atoms (such as benzenesulfenyl), halogen atoms, alkynyl groups having 2 to 10 carbon atoms (such as ethynyl), diacylamino groups having 2 to 10 carbon atoms (such as diacetylamino), a phosphoryl group, a carboxyl group, and five- or six-membered heterocyclic groups (such as 2-benzothiazolyl, 2-benzoxazolyl, 3-pyridyl, 5-(1H)-tetrazolyl, and 4-pyrimidyl); and preferably, a cyano group, alkoxycarbonyl group, alkylsulfonyl group, and arylsulfonyl group.

In Formula (I), examples of the substituent groups on the methine carbon represented by R include the followings: linear or cyclic alkyl groups having 1 to 20 carbon atoms (such as methyl, ethyl, n-propyl, isopropyl, and n-butyl), substituted or unsubstituted aryl groups having 6 to 18 carbon atoms (such as phenyl, chlorophenyl, anisyl, toluoyl, 2,4-di-t-amyl, and 1-naphthyl), alkenyl groups (such as vinyl and 2-methylvinyl), alkynyl groups (such as ethynyl, 2-methyl ethynyl, and 2-phenylethynyl), halogen atoms (such as F, Cl, Br, and I), a cyano group, a hydroxyl group, a carboxyl group, acyl groups (such as acetyl, benzoyl, saliciloyl, and pivaloyl), alkoxy groups (such as methoxy, butoxy, and cyclohexyloxy), aryloxy groups (such as phenoxy and 1-naphthoxy), alkylthio groups (such as methylthio, butylthio, benzylthio, and 3-methoxypropylthio), arylthio groups (such as phenylthio and 4-chlorophenylthio),

alkylsulfonyl groups (such as methanesulfonyl and butane sulfonyl), arylsulfonyl groups (such as benzenesulfonyl and para-toluenesulfonyl), carbamoyl groups having 1 to 10 carbon atoms, amido groups having 1 to 10 carbon atoms, imido groups having 2 to 12 carbon atoms, acyloxy groups having 2 to 10 carbon atoms, alkoxycarbonyl groups having 2 to 10 carbon atoms, and heterocyclic groups (including aromatic hetero rings such as pyridyl, thienyl, furyl, thiazolyl, imidazolyl, and pyrazolyl; and aliphatic hetero rings such as pyrrolidine ring, piperidine ring, morpholine ring, pyran ring, thiopyran ring, dioxane ring, and dithiolane ring).

Favorable examples of the substituents R include halogen atoms, linear or cyclic alkyl groups having 1 to 8 carbon atoms, aryl groups having 6 to 10 carbon atoms, alkoxy groups having 1 to 8 carbon atoms, aryloxy groups having 6 to 10 carbon atoms, and heterocyclic groups having 3 to 10 carbon atoms; particularly preferable are a chlorine atom, alkyl groups having 1 to 4 carbon atoms (such as methyl, ethyl, and isopropyl), a phenyl group, alkoxy groups having 1 to 4 carbon atoms (such as methoxy and ethoxy), a phenoxy group, and nitrogen-containing heterocyclic groups having 4 to 8 carbon atoms (such as 4-pyridyl, benzoxazole-2-yl, and benzothiazole-2-yl).

n is an integer of 0 to 2m+1, and when n is an integer of 2 or more, multiple groups R may be the same as or different from each other and may bind to each other forming a ring. Then, the number of rings is preferably 4 to 8, particularly preferably 5 or 6, and the atoms constituting the ring are preferably carbon and oxygen or nitrogen, and particularly preferably carbon.

A, B, C, D and R may further have a substituent group, and examples of the substituent groups include those of the monovalent substituent groups for the group represented by R in Formula (I).

In the dye for use in optical disk, A and B or C and D preferably bind to each other forming a ring, from the viewpoint of thermal decomposition, and examples of the rings include the followings (A-1 to A-66): In the following examples, Ra, Rb and Rc each independently represent a hydrogen atom or a substituent group.

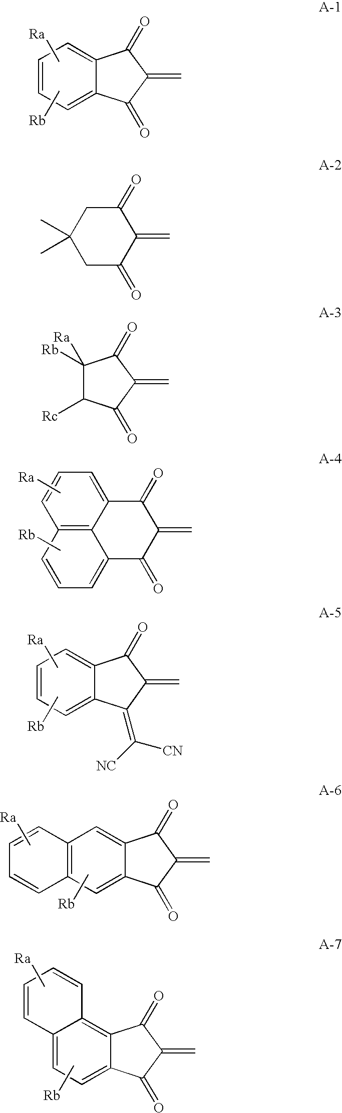

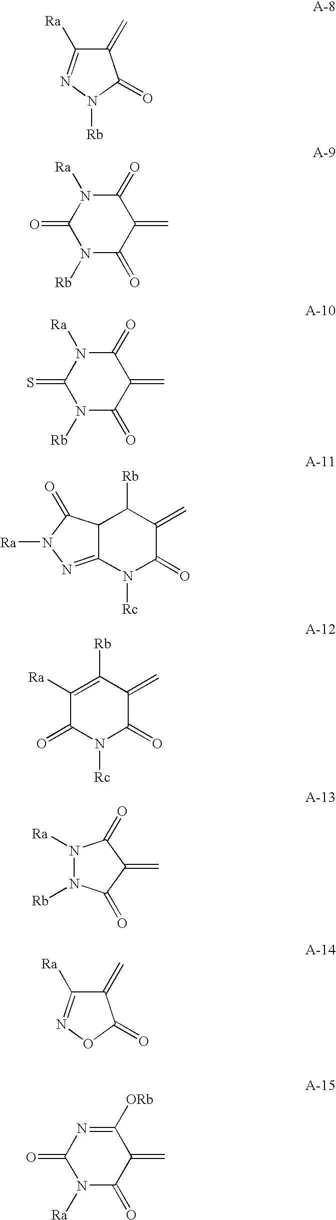

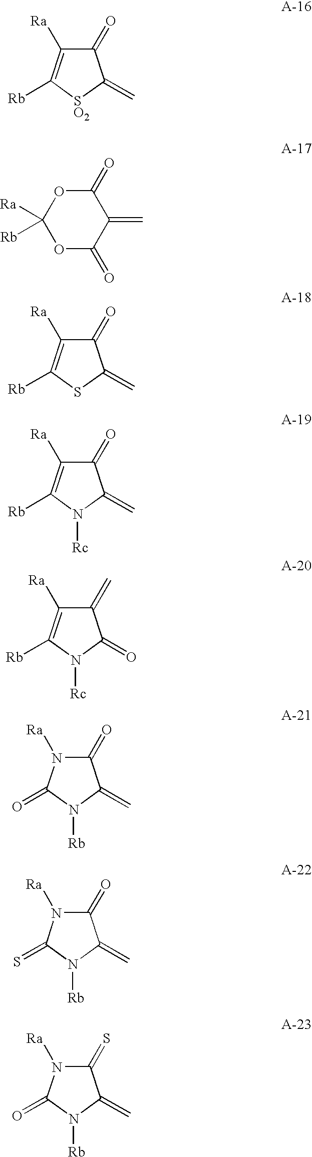

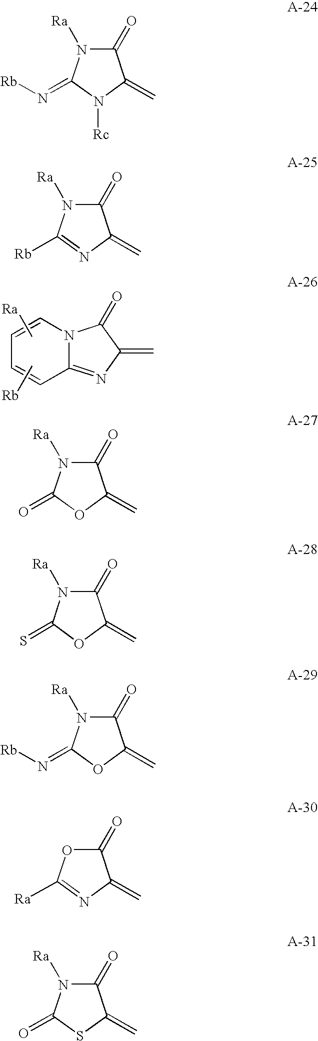

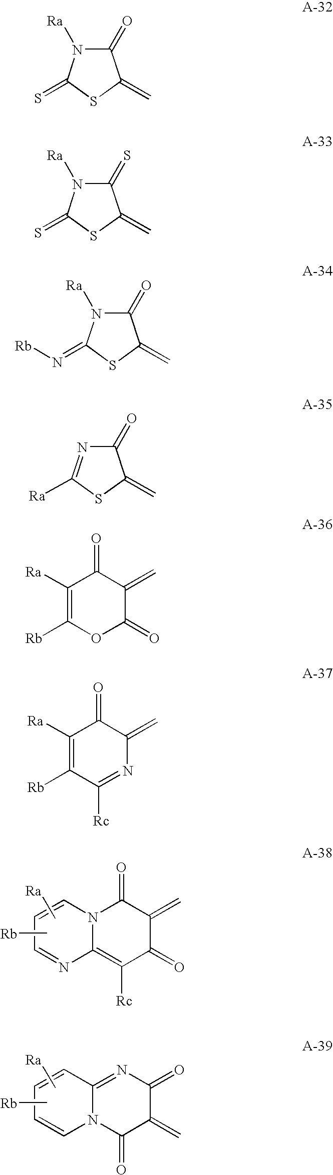

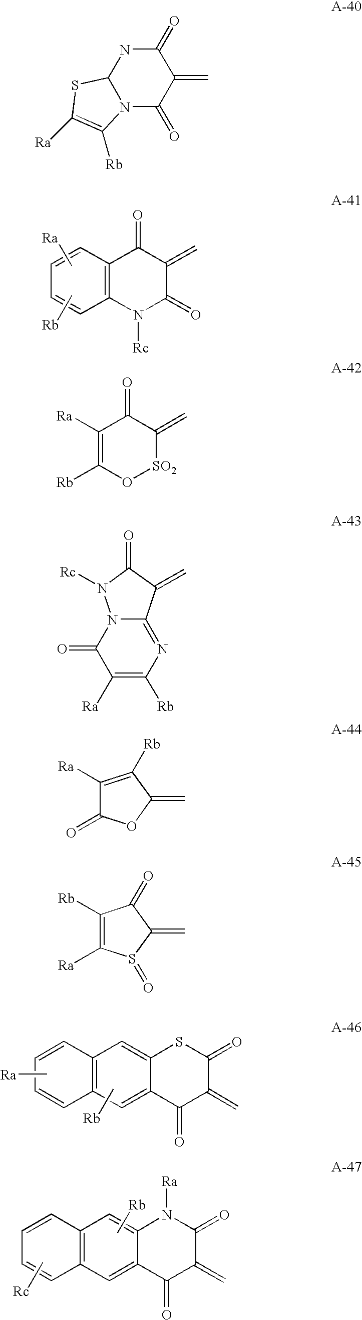

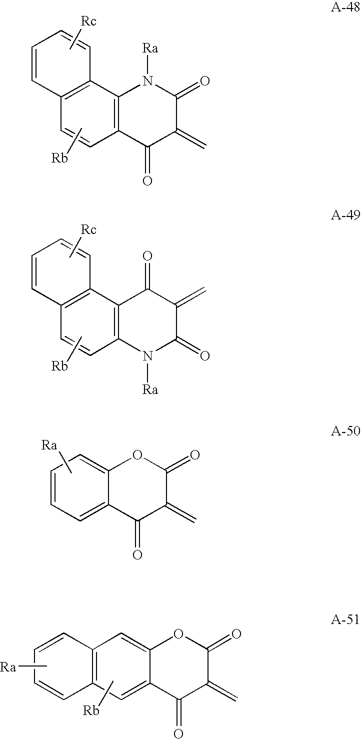

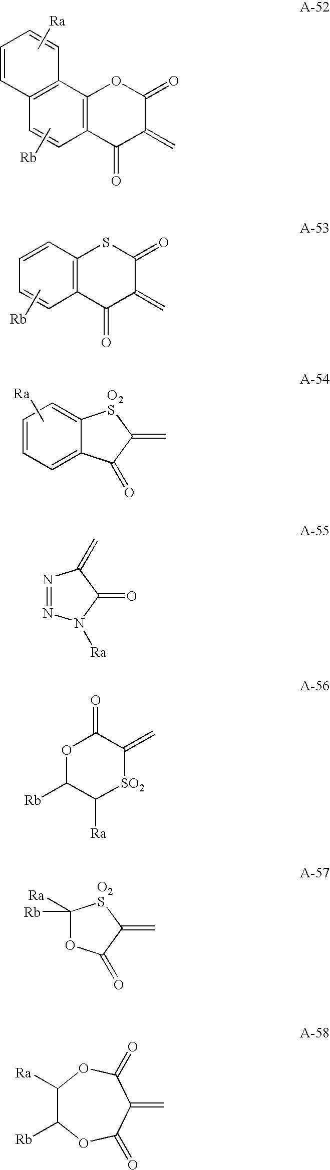

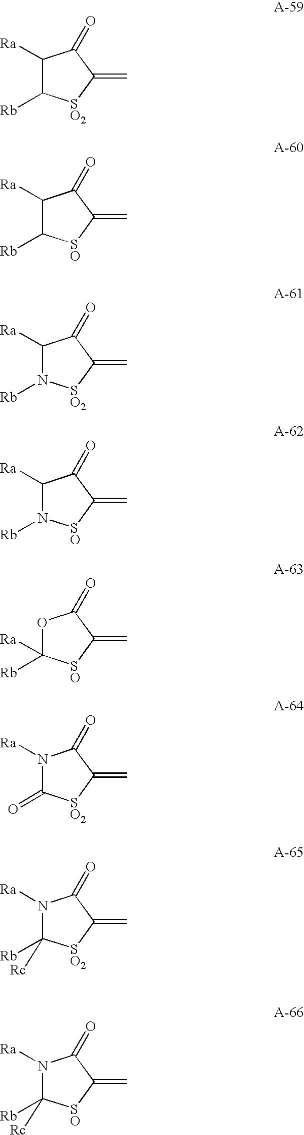

Among the rings above, preferable are the rings represented by A-2, A-8, A-9, A-10, A-13, A-14, A-16, A-17, A-36, A-39, A-42, A-54, A-57, A-59, A-61, A-65 and A-66. More preferable are those represented by A-2, A-9, A-10, A-13, A-17, A-42, A-54, A-57, A-59, A-61, A-65 and A-66. Most preferable are those represented by A-13, A-17, A-54, A-57, A-59, A-61, A-65 and A-66.

The substituent groups represented by Ra, Rb and Rc are respectively the same as the substituent groups represented by R. Ra, Rb and Rc may bind to each other, forming a carbocyclic or heterocyclic ring. Examples of the carbocyclic rings include saturated or unsaturated four- to seven-membered carbocyclic rings such as cyclohexyl ring, cyclopentyl ring, cyclohexene ring, and benzene ring. Examples of the heterocyclic rings include saturated or unsaturated four- to seven-membered heterocyclic rings such as piperidine ring, piperazine ring, morpholine ring, tetrahydrofuran ring, furan ring, thiophene ring, pyridine ring, and pyrazine ring. These carbocyclic ring and heterocyclic ring may further be substituted. The groups which may further be substituted are the same as those exemplified for the substituent group represented by R.

In Formula (I), m is an integer of 0 to 3, and the absorption wavelength of the oxonol dye varies significantly depend on the value of m. it is needed to design a dye having the optimal absorption wavelength according to the oscillation wavelength of the laser for use in record reproduction, and thus, selection of the value of m is important in this point. m in Formula (I) is preferably 2 or 3 when the central oscillation wavelength of the laser for use in record reproduction is 780 nm (semiconductor laser for CD-R recording); m is preferably 1 or 2 when the central oscillation wavelength is 635 nm or 650 nm (semiconductive laser for DVD-R recording); and m is preferably 0 or 1 when the central oscillation wavelength is 550 nm or less (for example, blue purple semiconductor laser having a central oscillation wavelength of 405 nm).

The oxonol chromophores represented by Formula (I) may bind to each other at any position forming a multimer, and, in such a case, the units may be the same as or different from each other and may bind to a polymer chain such as polystyrene, polymethacrylate, polyvinylalcohol, or cellulose.

In Formula (I), any one of A, B, C, D, and R may bind to the connecting group L¹¹ or L^{2k} forming the dye moiety of Formula (I) with its hydrogen atom removed.

Typical examples of the cyanine dye, merocyanine dye and oxonol dye include those described in F. M. Harmer, Heterocyclic Compounds—Cyanine Dyes and Related Compounds, John Wiley & Sons, New York, London, 1964.

The methine dye is preferably an oxonol dye represented by any of Formula (2-1), (2-2), (2-3), (2-4), and (2-5).

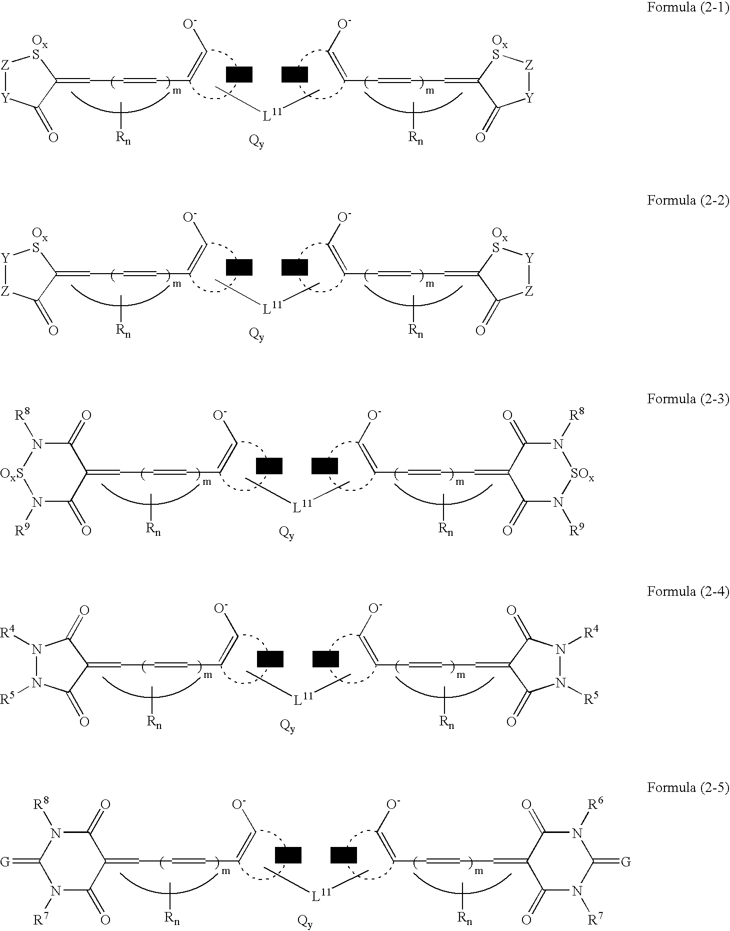

In the Formulae (2-1), (2-2), (2-3), (2-4), and (2-5), R represents a substituent group on the methine carbon; m represents an integer of 0 to 1; n represents an integer of 0 to 2 m+1; when n is an integer of 2 or more, multiple groups R may be the same as or different from each other, or may bind to each other forming a ring; Za⁵ and Za⁶ each represent an atom group forming an acidic nucleus; The definitions of L¹¹, Q, and y are the same as L¹¹, Q, and y in Formula (I); Y represents any of —O—, —NR¹— and —CR²R³—; R¹ to R⁹ each independently represents a hydrogen atom or a substituent group; Z represents a substituted or unsubstituted alkylene group; and x represents 1 or 2. G represents an oxygen atom or sulfur atom, preferably an oxygen atom.

The substituent group represented by R¹ to R⁹ is not particularly limited, and examples thereof include those of the substituent groups represented by R in Formula (I), and the preferable range of examples thereof is also the same. Z represents a substituted or unsubstituted alkylene group. Favorable examples of the alkylene groups include substituted or unsubstituted methylene groups, substituted or unsubstituted ethylene groups, and substituted or unsubstituted propylene groups; more preferable examples thereof include substituted or unsubstituted methylene groups and substituted or unsubstituted ethylene groups; and still more preferable are substituted or unsubstituted methylene groups.

m in Formulae (2-1), (2-2), (2-3), (2-4), and (2-5) is preferably 0.

Optical information-recording media containing a dye having a structure represented by the following Formula (5-1), (5-2), (5-3), (5-4), or (5-5) among the dyes represented by Formula (I) are preferable.

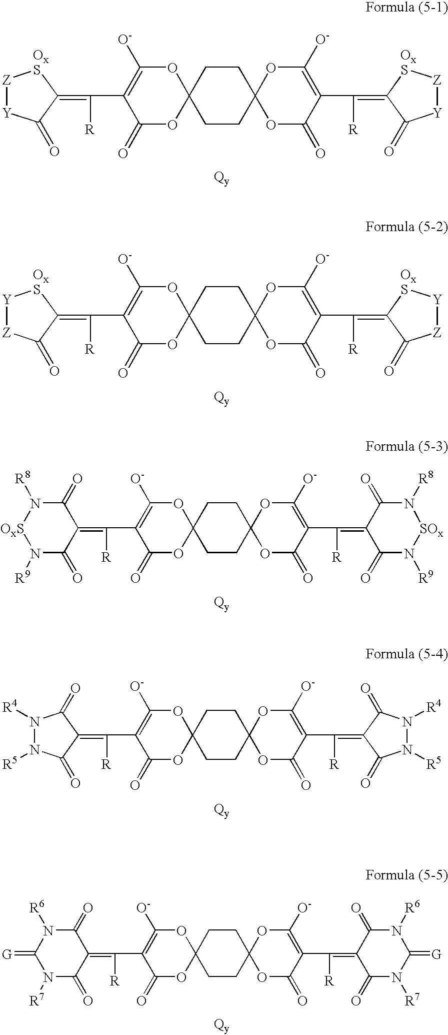

The definitions of R, Z, Y, Q, y, and x in Formulae (5-1), (5-2), (5-3), (5-4), and (5-5) are the same as R, Z, Y, Q, y, and x in Formulae (2-1) to (2-5). R¹ to R⁹ each independently represents a hydrogen atom or a substituent group; and G represents an oxygen atom or sulfur atom.

Examples of Za¹, Za² and Za³ include oxazole nucleus having 3 to 25 carbon atoms (such as 2-3-methyloxazolyl, 2-3-ethyloxazolyl, 2-3,4-diethyloxazolyl, 2-3-methylbenzoxazolyl, 2-3-ethylbenzoxazolyl, 2-3-sulfoethylbenzoxazolyl, 2-3-sulfopropylbenzoxazolyl, 2-3-methyltlhioethylbenzoxazolyl, 2-3-methoxyethylbenzoxazolyl, 2-3-sulfobutylbenzoxazolyl, 2-3-methyl-β-naphthoxazolyl, 2-3-methyl-α-naphthoxazolyl, 2-3-sulfopropyl-β-naphthoxazolyl, 2-3-sulfopropyl-β-naphthoxazolyl, 2-3-(3-naphthoxyethyl)benzoxazolyl, 2-3,5-dimethylbenzoxazolyl, 2-6-chloro-3-methylbenzoxazolyl, 2-5-bromo-3-methylbenzoxazolyl, 2-3-ethyl-5-methoxybenzoxazolyl, 2-5-phenyl-3-sulfopropylbenzoxazolyl, 2-5-(4-bromophenyl)-3-sulfobutylbenzoxazolyl, and 2-3-dimethyl-5,6-dimethylthiobenzoxazolyl),

thiazole nucleus having 3 to 25 carbon atoms (such as 2-3-methylthiazolyl, 2-3-ethylthiazolyl, 2-3-sulfopropylthiazolyl, 2-3-sulfobutylthiazolyl, 2-3,4-dimethylthiazolyl, 2-3,4,4-trimethylthiazolyl, 2-3-carboxyethylthiazolyl, 2-3-methylbenzothiazolyl, 2-3-ethylbenzothiazolyl, 2-3-butylbenzothiazolyl, 2-3-sulfopropylbenzothiazolyl, 2-3-sulfobutylbenzothiazolyl, 2-3-methyl-β-naphthothiazolyl, 2-3-sulfopropyl-γ-naphthothiazolyl, 2-3-(1-naphthoxyethyl)benzothiazolyl, 2-3,5-dimethylbenzothiazolyl, 2-6-chloro-3-methylbenzothiazolyl, 2-6-iodo-3-ethylbenzothiazolyl, 2-5-bromo-3-methylbenzothiazolyl, 2-3-ethyl-5-methoxybenzothiazolyl, 2-5-phenyl-3-sulfopropylbenzothiazolyl, 2-5-(4-bromophenyl)-3-sulfobutylbenzothiazolyl, and 2-3-dimethyl-5,6-dimethylthiobenzothiazolyl), imidazole nucleus having 3 to 25 carbon atoms (such as 2-1,3-diethylimidazolyl, 2-1,3-dimethylimidazolyl, 2-1-methylbenzimidazolyl, 2-1,3,4-triethylimidazolyl, 2-1,3-diethylbenzimidazolyl, 2-1,3,5-trimethylbenzimidazolyl, 2-6-chloro-1,3-dimethylbenzimidazolyl, 2-5,6-dichloro-1,3-diethylbenzimidazolyl, and 2-1,3-disulfopropyl-5-cyano-6-chlorobenzimidazolyl),

indolenine nucleus having 10 to 30 carbon atoms (such as 3,3-dimethylindolenine), quinoline nucleus having 9 to 25 carbon atoms (such as 2-1-methylquinolyl, 2-1-ethylquinolyl, 2-1-methyl-6-chloroquinolyl, 2-1,3-diethylquinolyl, 2-1-methyl-6-methylthioquinolyl, 2-1-sulfopropylquinolyl, 4-1-methylquinolyl, 4-1-sulfoethylquinolyl, 4-1-methyl-7-chloroquinolyl, 4-1,8-diethylquinolyl, 4-1-methyl-6-methylthioquinolyl, and 4-1-sulfopropylquinolyl), selenazole nucleus having 3 to 25 carbon atoms (such as 2-3-methylbenzoselenazolyl), and pyridine nucleus having 5 to 25 carbon atoms (such as 2-pyridyl), as well as thiazoline nucleus, oxazoline nucleus, selenazoline nucleus, tellurazoline nucleus, tellurazole nucleus, benzotellurazole nucleus, imidazoline nucleus, imidazo[4,5-quinoxaline]nucleus, oxadiazole nucleus, thiadiazole nucleus, tetrazole nucleus, and pyrimidine nucleus.

These may further be substituted, and favorable examples of the substituent groups include alkyl groups (such as methyl, ethyl, and propyl), halogen atoms (such as chlorine, bromine, iodine, and fluorine), a nitro group, alkoxy groups (such as methoxy and ethoxy), aryl groups (such as phenyl), heterocyclic groups (such as 2-pyridyl, 3-pyridyl, 1-pyrrolyl, and 2-thienyl), aryloxy groups (such as phenoxy), acylamino groups (such as acetylamino and benzoylamino), carbamoyl groups (such as N,N-dimethylcarbamoyl), a sulfo group, sulfonamide groups (such as methanesulfonamide), sulfamoyl groups (such as N-methylsulfamoyl), a hydroxy group, a carboxy group, alkylthio groups (such as methylthio), and a cyano group; and preferable are oxazole nucleus, imidazole nucleus, and thiazole nucleus. These heterocyclic rings may further be fused with another ring. Examples of the rings which may be fused with include benzene ring, benzofuran ring, pyridine ring, pyrrole ring, indole ring, and thiophene ring, and the like.

Za⁴, Za⁵ and Za⁶ each represent an atom group needed for forming an acidic nucleus, and are defined in James Ed., The Theory of the Photographic Process, 4th Ed., McMillan, 1977, p. 198. Specific examples thereof include nucleus of 2-pyrazolon-5-one, pyrazolidine-3,5-dione, imidazolin-5-one, hydantoin, 2- or 4-thiohydantoin, 2-iminooxazoridin-4-one, 2-oxazolin-5-one, 2-thiooxazolin-2,4-dione, isorhodanine, rhodanine, indan-1,3-dione, thiophen-3-one, thiophen-3-one-1,1-dioxide, indolin-2-one, indolin-3-one, 2-oxoindazolium, 5,7-dioxo-6,7-dihydrothiazolo[3,2-a]pyrimidine, 3,4-dihydroisoquinolin-4-one, 1,3-dioxane-4,6-dione, barbituric acid, 2-thiobarbituric acid, coumarin-2,4-dione, indazolin-2-one, pyrido[1,2-a]pyrimidin-1,3-dione, pyrazolo[1,5-b]quinazolone, pyrazolopyridone, 3-dicyanomethylidenyl-3-phenylpropionitrile, oxathiolanone dioxide, or Meldrum's acid; and preferable are 2-pyrazolon-5-one, barbituric acid, 2-thiobarbituric acid, oxathiolanone dioxide, Meldrum's acid, and pyrazolidine-3,5-dione.

In Formula (I), each of L¹¹ and L^{2k} independently represents a bivalent connecting group and is not particularly limited except it does not form a 7-conjugation system with the chromophores bound thereto, and favorable examples thereof include alkylene groups (having 1 to 20 carbon atoms, such as methylene, ethylene, propylene, butylene, and pentylene), arylene groups (having 6 to 26 carbon atoms, such as phenylene and naphthylene), alkenylene groups (having 2 to 20 carbon atoms, such as ethenylene and propenylene), alkynylene groups (having 2 to 20 carbon atoms, such as ethynylene and propynylene), metallocenylene groups (e.g., ferrocene), —CO—N(R¹⁰¹)—, —CO—O—, —SO₂—N(R¹⁰²)—, —SO₂—O—, —N(R¹⁰³)—CO—N(R¹⁰⁴)—, —SO₂—, —SO—, —S—, —O—, —CO—, —N(R¹⁰⁵)—, and connecting groups having 0 to 100 or less carbon atoms, preferably 1 or more and 20 or less and having one or more heterylene groups (having 1 to 26 carbon atoms, such as 6-chloro-1,3,5-triazyl-2,4-diyl group and pyrimidine-2,4-diyl group). R^{10l}, R¹⁰², R¹⁰³, R¹⁰⁴, and R¹⁰⁵ above each independently represent a hydrogen atom, a substituted or unsubstituted alkyl group, or a substituted or unsubstituted aryl group. In addition, one or multiple connecting groups represented by L¹¹ or L^{2k} above may be present between the two chromophore bound thereto, and the multiple connecting groups (preferably two) may bind to each other forming a ring. Each of L¹¹ and L^{2k} is preferably a ring formed by binding of two alkylene group (preferably, ethylene). In particular, it is still more preferably a five- or six-membered ring (preferably cyclohexyl).

In Formula (1), n represents an integer of 0 to 10, preferably an integer of 0 to 5, more preferably an integer of 0 to 3, and particularly preferably an integer of 0 to 2.

In Formula (1), k represents an integer of 0 or more and n or less. For example when n is 2, k is an integer of 0, 1, or 2; and Dye^{2k} and L^{2k} each independently represent the chromophore of Dye²⁰, Dye²¹, or Dye and the connecting group of L²⁰, L²¹, or L²². When n is an integer of 2 or more, multiple groups Dye^{2k} may be the same as or different from each other. Multiple groups L^{2k} may also be the same as or different from each other when n represents an integer of 2 or more.

In Formula (1), Q represents an ion for neutralizing the electric charge; and y represents the number of the ions need for neutralizing the electric charge. It depends on the substituent group of a compound whether the compound is a cationic or anionic ion, or has a net ionic charge. The ion represented by Q in Formulae (1) and (3) to (5) may represent a cationic or an anionic according to the corresponding electric charge of the dye molecule, and Q is absent when the dye molecule carries no electric charge. The ionic charge of the ion represented by Q is not particularly limited and may be an ion of inorganic or organic compound. The ion represented by Q may be monovalent or polyvalent. Examples of the cations represented by Q include metal ions such as sodium ion and potassium ion, and ollium ions such as quaternary ammonium ion, oxonium ion, sulfonium ion, phosphonium ion, selenonium ion, and iodonium ion. On the other hand, examples of the anions represented by Q include halogen anions such as chloride ion, bromide ion, and fluoride ion; hetero polyacid ions such as sulfate ion, phosphate ion, and biphosphate ion; organic polyvalent anions such as succinate ion, maleate ion, fumarate ion, and aromatic disulfonate ion; and tetrafluoroborate ion and hexafluorophosphate ion.

The cation represented by Q is preferably an onium ion and more preferably a quaternary ammonium ion. Among the quaternary ammonium ions, particularly preferable are the 4,4′-bipyridinium cations represented by Formula (I-4) of JP-A No. 2000-52658 and the 4,4′-bipyridinium cations disclosed in JP-A No. 2002-59652.

The anion represented by Q is preferably a tetrafluoborate ion, hexafluorophosphate ion, or organic polyvalent anion, more preferably a bivalent or trivalent organic anion such as naphthalenedisulfonate derivative. Among the bivalent or trivalent organic anions, particularly preferable are the naphthalenedisulfonate anions disclosed in JP-A No. 10-226170.

Among the dyes represented by Formula (I), dyes having a structure represented by the following Formula (2-1), (2-2), (2-3), (2-4) or (2-5) are preferable.

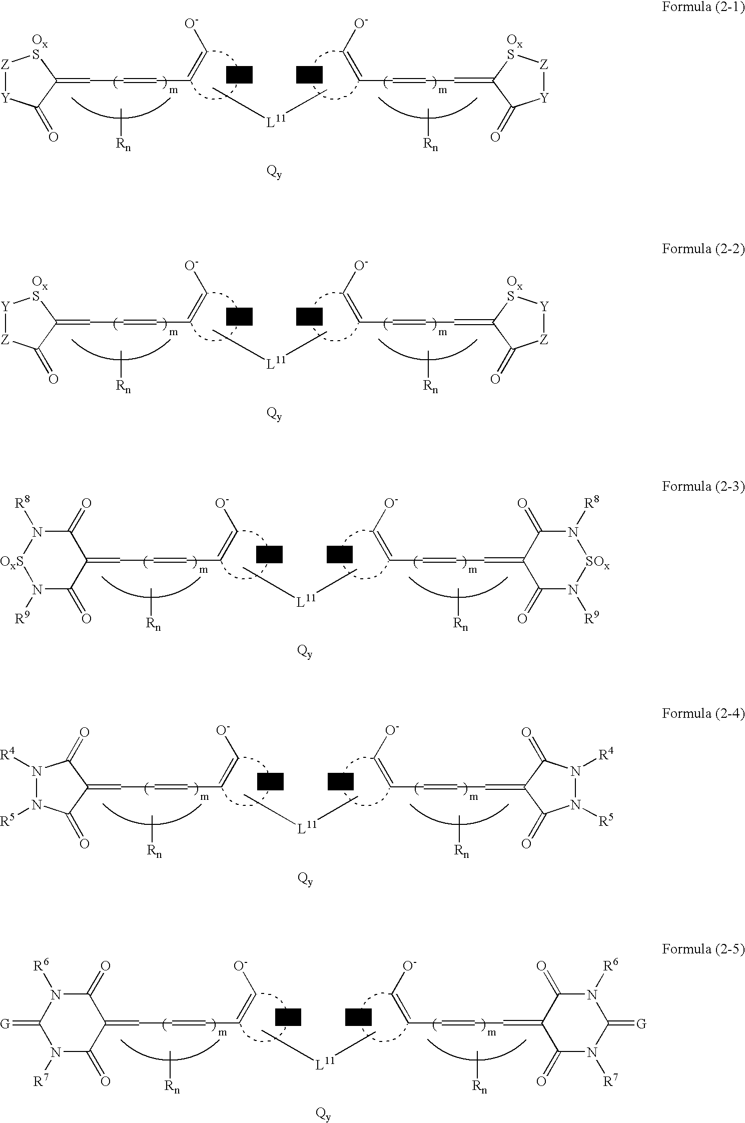

The dyes represented by Formulae (2-1), (2-2), and (2-3) will be described below. Y represents any of —O—, —NR¹— and —CR²R³. Y is preferably —O— or —CR²R³— and more preferably —O—.

R¹ to R⁹ each independently represent a hydrogen atom or a substituent group. The substituent group represented by R¹ to R⁹ is not particularly limited, and examples thereof include those of the substituent groups represented by R in Formula (I), and the preferable examples thereof are also the same.

z represents a substituted or unsubstituted alkylene group. Favorable examples of the alkylene groups include substituted or unsubstituted methylene groups, substituted or unsubstituted ethylene groups, and substituted or unsubstituted propylene group; more preferably examples include substituted or unsubstituted methylene groups and substituted or unsubstituted ethylene groups; and still more preferably examples include substituted or unsubstituted methylene groups.

x represents 1 or 2, preferably 2.

G represents an oxygen atom or sulfur atom, preferably an oxygen atom.

In Formulae (2-1), (2-2), (2-3), (2-4) and (2-5) above, R represents a substituent group on the methine carbon; m represents an integer of 0 to 1; n represents an integer of 0 to 2m+1; when n is an integer of 2 or more, multiple groups R may be the same as or different from each other, or may bind to each other forming a ring; Za⁵ and Za⁶ each represent an atom group forming an acidic nucleus; The definitions of L¹¹, Q, and y are the same as L¹¹, Q, and y in Formula (I).

Among the structures represented by the Formulae (2-1), (2-2), (2-3), (2-4), and (2-5), preferable are the dyes in which m is 0.

Among the dyes represented by Formulae (2-1), (2-2), (2-3), (2-4) and (2-5) above, dyes having a structure represented by the following Formula (5-1), (5-2), (5-3), (5-4), or (5-5) are most preferable, from the viewpoint of light stability and good degradability.

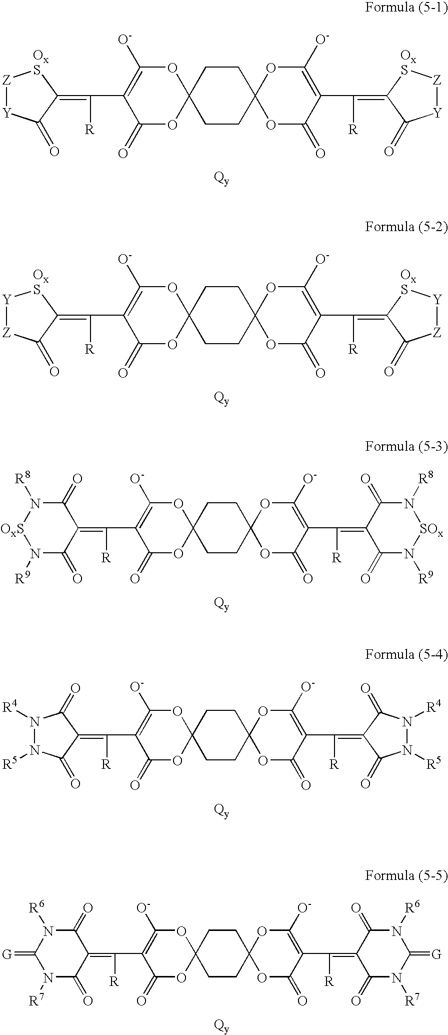

In Formulae (5-1), (5-2), (5-3), (5-4), and (5-5), R¹ to R⁹, R, x, Y, Z, Q, y, and G are the same as those in Formulae (2-1), (2-2), (2-3), (2-4), and (2-5).

Hereinafter, typical favorable examples of the compounds represented by Formulae (1) and (2) according to the invention (S-1 to S-27) will be listed, but the invention is not limited thereto.

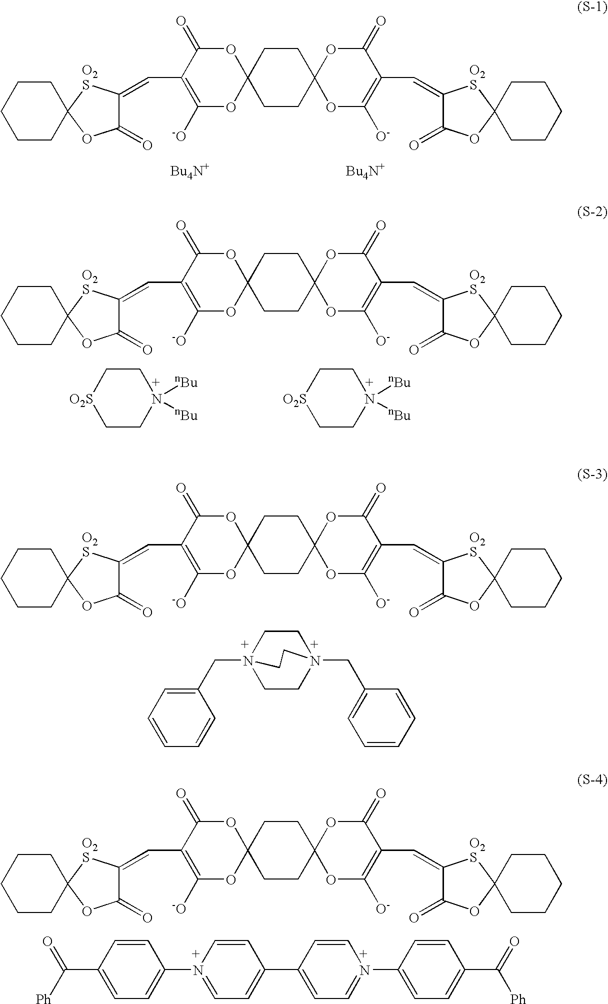

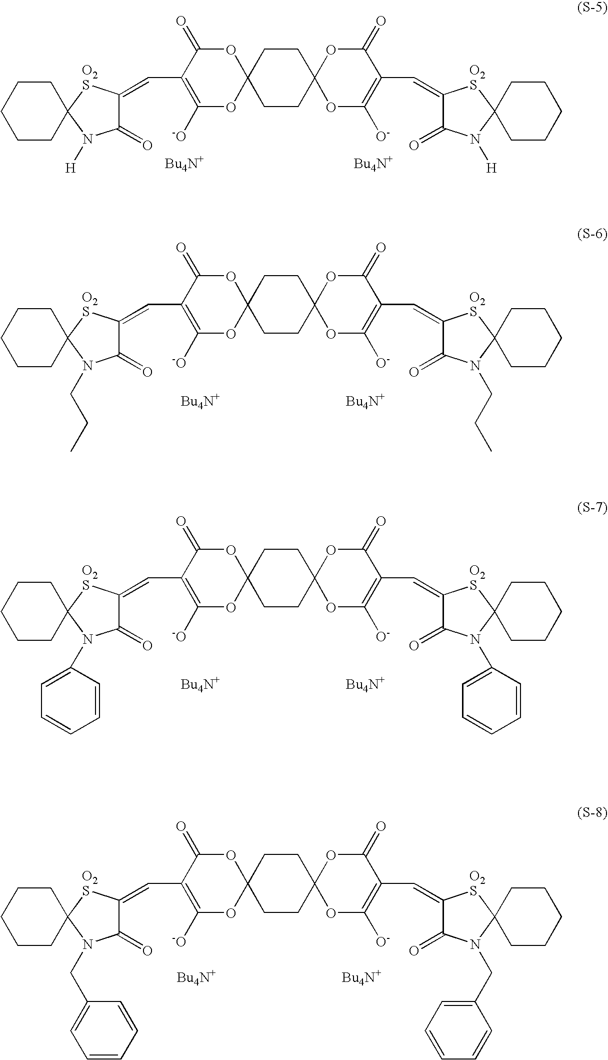

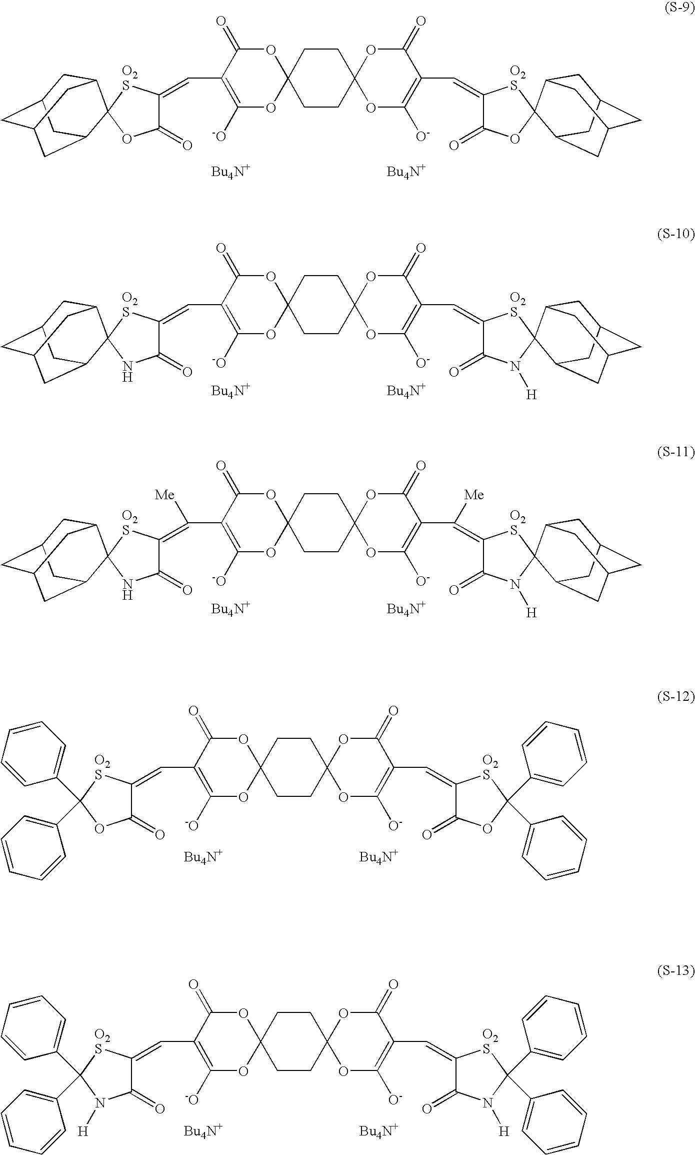

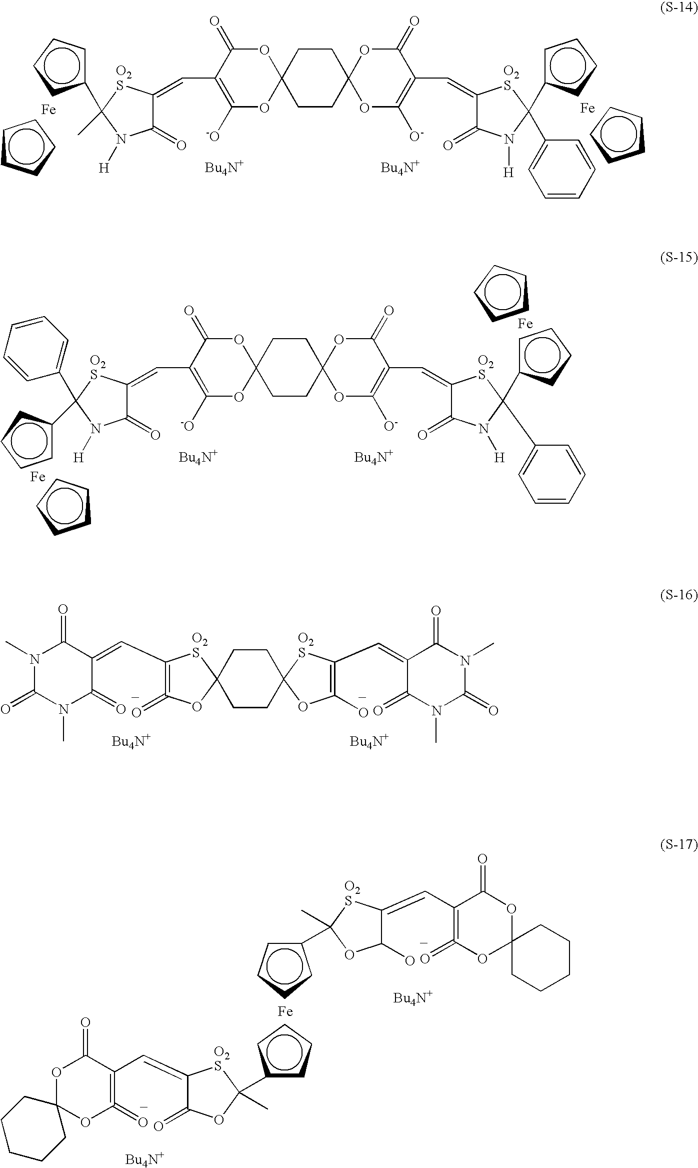

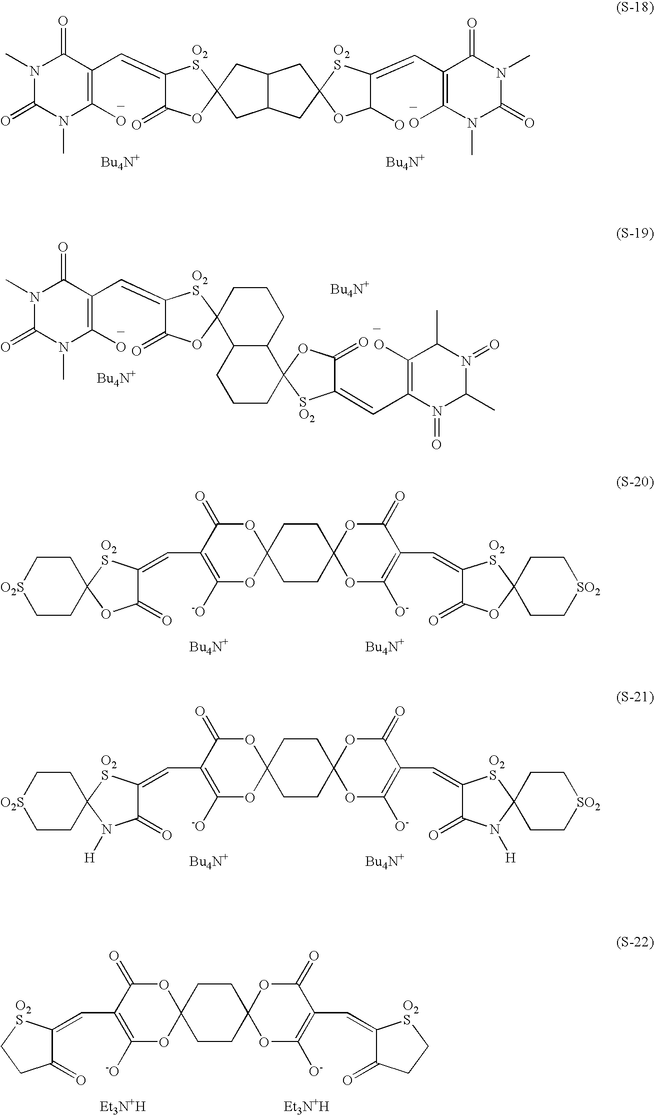

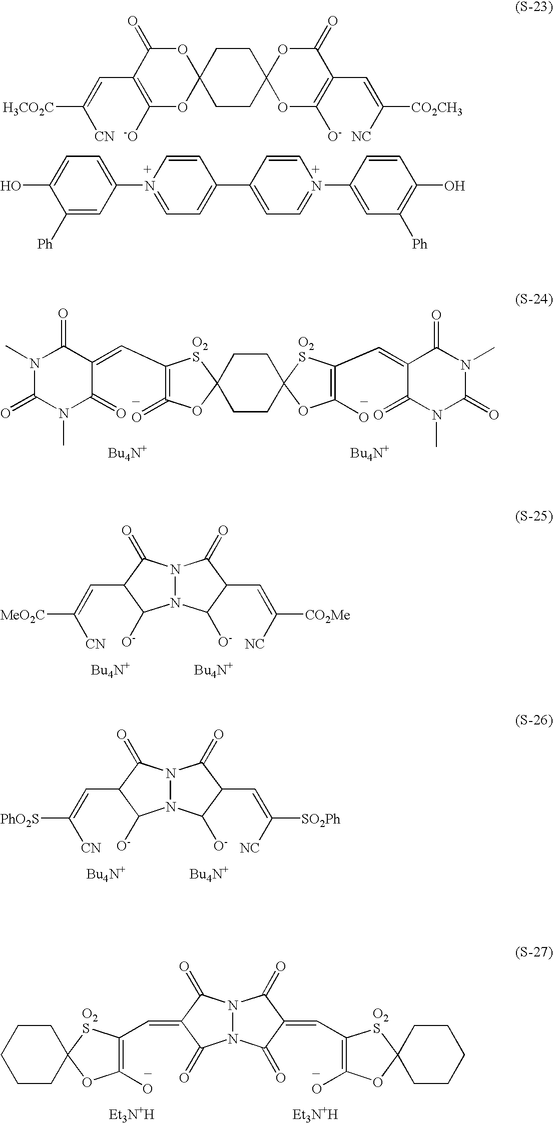

Typical compounds favorably used in the invention are shown in the following Table 1.

TABLE 1

| | | |
|---|---|---|
| Compound No. | (S-1) | (S-4) |
| | (S-5) | (S-23) |

The dye compounds according to the invention represented by Formula (I) may be used alone or in combination of two or more. Alternatively, the dye compound according to the invention may be used in combination with other dye compound.

In the recording layer of the information recording medium of the invention, in order to increase the light resistance of the recording layer, various kinds of the fading resistance agents can be contained.

As for the fading resistance agent, an organic oxidant and a singlet oxygen quencher can be used. As the organic oxidant, the compounds described in JP-A No. 10-151861 can be used. As the singlet oxygen quencher, those described in the publication such as the already known patent specification can be used.

Specific examples of that include ones described in JP-A Nos. 58-175693, 59-81194, 60-18387, 60-19586, 60-19587, 60-35054, 60-36190, 60-36191, 60-44554, 60-44555, 60-44389, 60-44390, 60-54892, 60-47069, 63-209995, 4-25492, Japanese Patent Application Publication (JP-B) Nos. 1-38680 and 6-26028; German Patent No. 350399; and Nippon Kagaku Kaishi, October (1992), p. 1141. Other preferable examples of the singlet oxygen quencher include the compounds represented by the following general formula (II).

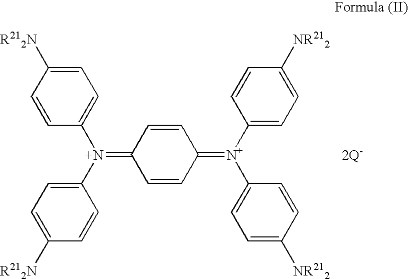

wherein R²¹ represents an alkyl group that may have a substituent and Q represents an anion.

In general formula (II), R²¹ is generally an alkyl group having 1 to 8 carbon atoms and may have a substituent, and preferably an unsubstituted alkyl group having 1 to 6 carbon atoms. Examples of the substituent for the alkyl group include a halogen atom (for example, F and Cl), an alkoxy group (for example, methoxy and ethoxy), an alkylthio group (for example, methylthio and ethylthio), an acyl group (for example, acetyl and propyonyl), an acyloxy group (for example, acetoxy and propionyloxy), a hydroxy group, an alkoxy carbonyl group (for example, methoxy carbonyl and ethoxycarbonyl), an alkenyl group (for example, vinyl), and an aryl group (for example, phenyl and naphthyl). A halogen atom, an alkoxy group, an alkylthio group, and an alkoxy carbonyl group are preferable. Preferable examples of the Q⁻ anion include ClO₄⁻, AsF₆⁻, BF₄⁻, and SbF₆⁻.

Examples of the compound (compound Nos. I I-1˜I I-8) represented by general formula (II) are shown in Table 2 below.

TABLE 2

| compound No. | R²¹ | Q⁻ |
|---|---|---|
| II-1 | CH₃ | CIO₄⁻ |
| II-2 | C₂H₅ | CIO₄⁻ |
| II-3 | n-C₃H₇ | CIO₄⁻ |
| II-4 | n-C₄H₉ | CIO₄⁻ |
| II-5 | n-C₅H₁₁ | CIO₄⁻ |
| II-6 | n-C₄H₉ | SbF₆⁻ |
| II-7 | n-C₄H₉ | BF₄⁻ |
| II-8 | n-C₄H₉ | AsF₆⁻ |

An amount used of the fading resistance agent such as the singlet oxygen quencher is, to an amount of the dye, generally in the range of 0.1 to 50 mass percent, preferably in the range of 0.5 to 45 mass percent, more preferably in the range of 3 to 40 mass percent and particularly preferably in the range of 5 to 25 mass percent.

### <Aspect of Optical Information-Recording Medium>

In an aspect (1) of the invention, the optical information-recording medium according to the invention is preferably an optical information-recording medium having a dye-containing write-once recording layer and a cover layer having a thickness of 0.01 to 0.5 mm in that order on a substrate having a thickness of 0.7 to 2 mm; and, in an aspect (2), it is preferably an optical information-recording medium having a dye-containing write-once recording layer and a protective substrate having a thickness of 0.1 to 1.0 mm in that order on a substrate having a thickness of 0.1 to 1.0 mm. In aspect (1) above, the pre-groove formed on the substrate preferably has a track pitch of 50 to 500 nm, a groove width of 25 to 250 nm, and a groove depth of 5 to 150 nm; and in aspect (2) above, the pre-groove formed on the substrate preferably has a track pitch of 200 to 600 nm, a groove width of 50 to 300 nm, a groove depth of 30 to 200 nm, and a wobble amplitude of 10 to 50 nm.

The optical information-recording medium of aspect (1) has at least a substrate, a write-once recording layer and a cover layer, and these important components will be described first one by one.

### [Substrate According to the Aspect (1)]

A pre-groove (guide groove) in the shape having a track pitch, a groove width (half value width), a groove depth, and a wobble amplitude all in the ranges below is formed essentially on the substrate of favorable aspect (1). The pre-groove is formed for giving the substrate with a recording density higher than that of CD-R or DVD-R, and is particularly favorable, for example when the optical information-recording medium according to the invention is used as a medium compatible with blue purple laser.

The pre-groove track pitch is preferably in the range of 50 to 500 nm, and the upper limit is preferably 420 nm or less, more preferably 370 nm or less, and still more preferably 330 nm or less. The lower limit is preferably 100 nm or more, more preferably 200 nm or more, and still more preferably 260 nm or more. A track pitch of less than 50 nm may lead to difficulty in forming the pre-groove accurately, generating a problem of crosstalk, while that of more than 500 nm may cause a problem of decrease in recording density.

The pre-groove width (half value width) is preferably in the range of 25 to 250 nm, and the upper limit thereof is preferably 200 nm or less, more preferably 170 nm or less, and still more preferably 150 nm or less. The lower limit thereof is preferably 50 nm or more, more preferably 80 nm or more, and still more preferably 100 nm or more. A pre-groove width of less than 25 nm may result in insufficient transfer of the groove during molding and increase in the error rate during recording, while that of more than 250 nm in broading the pit formed during recording, causing crosstalk, and insufficient modulation.

The pre-groove depth is preferably in the range of 5 to 150 nm, and the upper limit thereof is preferably 100 nm or less, more preferably 70 nm or less, and still more preferably 50 nm or less. The lower limit thereof is preferably 10 nm or more, more preferably 20 nm or more, and still more preferably 28 nm or more. A pre-groove depth of less than 5 nm may result in insufficient recording modulation, while that of more than 150 nm in drastic decrease in reflectance.

An upper limit of an angle of the pre-groove is preferably 80° or less, more preferably 70° or less, still more preferably 60° or less, and particularly preferably 50° or less. Furthermore, a lower limit of the angle of the pre-groove is preferably 20° or more, more preferably 30° or more, and still more preferably 40° or more.

A pre-groove angle of less than 20° may result in insufficient tracking error signal amplitude, while that of more than 80° in difficulty in molding.

As a substrate in the invention, various materials used as substrate materials in existing optical information recording medium can be arbitrarily selected and used.

Specific examples of the material include glass; polycarbonates; acrylic resins such as polymethylmethacrylate; vinyl chloride base resins such as polyvinyl chloride and vinyl chloride copolymer; epoxy resins; amorphous polyloefins; polyesters; and metals such as aluminum, and a combination of two or more kinds thereof can be used if desired.

Among the materials mentioned above, from viewpoints of the moisture resistance, the dimensional stability and the low cost, thermoplastic resins such as amorphous polyolefins and polycarbonate are preferable, and polycarbonate is particularly preferable.

In the case of such resins being used, a substrate can be manufactured by means of injection molding.

It is required that a thickness of the substrate is in the range of 0.7 to 2 mm. Preferably it is in the range of 0.9 to 1.6 mm, and more preferably, in the range of 1.0 to 1.3 mm.

On a surface of the substrate that is on a side where an optical reflective layer mentioned below is disposed, in order to improve the planarity and to increase the adhesive force, an undercoat layer is preferably formed.

Examples of the materials of the undercoat layer include polymers such as polymethyl methacrylate, acrylate-methacrylate copolymers, styrene-maleic anhydride copolymers, polyvinyl alcohol, N-methylol acrylamide, styrene-vinyl toluene copolymers, chlorosulfonated polyethylene, cellulose nitrate, polyvinyl chloride, chlorinated polyolefin, polyester, polyimide, vinyl acetate-vinyl chloride copolymers, ethylene-vinyl acetate copolymers, polyethylene, polypropylene and polycarbonate; and a surface modifier such as silane coupling agents.

The undercoat layer can be formed by preparing a coating solution by dissolving or dispersing the material mentioned above in an adequate solvent, followed by coating the coating solution on the surface of the substrate by means of a coating method such as a spin coat method, a dip coat method or an extrusion coat method. In general, a film thickness of the undercoat layer is in the range of 0.05 to 20 μm, and preferably in the range of 0.01 to 10 μm.

[Write-Once Recording Layer according to the Aspect (1)]

A favorable write-once recording layer of aspect (1) is prepared by preparing a coating solution by dissolving a dye (the dye having two or more independent dye moieties in the molecule above mentioned, and the dye moieties are bound to each other without a conjugated bond described above) together with a binder and others in a suitable solvent, and forming a coated film by coating the coating solution on a substrate or the light-reflective layer described below, and drying the coated film. Here, the write-once recording layer may be either mono-layered or multi-layered. In the case of the write-once recording layer having a multi-layered configuration, the recording layer can be formed by carrying out the coating step a plurality of times.

A concentration of the dye in the coating solution is generally in the range of 0.01 to 15 mass percent, preferably in the range of 0.1 to 10 mass percent, more preferably in the range of 0.5 to 5 mass percent, and most preferably in the range of 0.5 to 3 mass percent.

Examples of the solvent for the coating solution include esters such as butyl acetate, ethyl lactate and cellosolve acetate; ketones such as methyl ethyl ketone, cyclohexanone, and methyl isobutyl ketone; chlorinated hydrocarbons such as dichloromethane, 1,2-dichloroethane and chloroform; amides such as dimethylformamide; hydrocarbons such as methylcyclohexane; ethers such as tetrahydrofuran, ethyl ether, and dioxane; alcohols such as ethanol, n-propanol, isopropanol, n-buthanol, and diacetone alcohol; fluorinated solvents such as 2,2,3,3-tetrafluoropropanol; and glycol ethers such as ethylene glycol monomethyl ether, ethylene glycol monoethyl ether and propylene glycol monomethyl ether.

The solvents mentioned above, in consideration of the solubility of the dye used, can be used singularly or in a combination of two or more kinds thereof. Furthermore, in the coating solution, various kinds of the additives such as an antioxidant, a UV absorbent, a plasticizer and a lubricant can be added in accordance with the purpose.

As the coating method, a spray method, a spin coat method, a dip method, a roll coat method, a blade coat method, a doctor roll method and a screen print method can be cited.

At the coating, a temperature of the coating solution is preferably in the range of 23 to 50 degrees centigrade, more preferably in the range of 24 to 40 degrees centigrade, among these particularly preferably in the range of 23 to 50 degrees centigrade.

A thickness of the write-once recording layer formed in this way is, on the groove (the projected portion on the substrate), preferably 300 nm or less, more preferably 250 nm or less, further more preferably 200 nm or less, and particularly preferably 180 nm or less. A lower limit thereof is preferably 30 nm or more, more preferably 50 nm or more, further more preferably 70 nm or more, and particularly preferably 90 nm or more.

Furthermore, a thickness of the write-once recording layer is, on a land (the concavity portion on the substrate), preferably 400 nm or less, more preferably 300 nm or less, and further more preferably 250 nm or less. A lower limit thereof is preferably 70 nm or more, more preferably 90 nm or more, and further more preferably 110 nm or more.

Still furthermore, a ratio of a thickness of the write-once recording layer on the groove to a thickness of the write-once recording layer on the land is preferably 0.4 or more, more preferably 0.5 or more, further more preferably 0.6 or more, and particularly preferably 0.7 or more. An upper limit thereof is preferably less than 1, more preferably 0.9 or less, further more preferably 0.85 or less, and particularly preferably 0.8 or less.

In the case of the coating solution containing a binding agent, examples of the binding agent include the natural organic polymers such as gelatin, cellulose derivatives, dextran, rosin and rubber; and synthetic organic polymers such as hydrocarbonic resins such as polyethylene, polypropylene, polystyrene and polyisobutylene, vinyl resins such as polyvinylchloride, polyvinylidene chloride and polyvinylchloride-polyvinyl acetate copolymers, acrylic resins such as polymethyl acrylate and polymethyl methacrylate, and initial condensates of thermosetting resins such as polyvinyl alcohol, chlorinated polyethylene, epoxy resin, butyral resin, rubber derivatives and phenol formaldehyde resin. In the case of the binding agent being used together as a material of the recording layer, an amount of the binding agent used is generally in the range of 0.01 to 50 times an amount of dye (mass ratio), and more preferably in the range of 0.1 to 5 times the amount of dye (mass ratio).

### [Cover Layer According to the Aspect (1)]

A cover layer according to the preferable aspect (1) is bonded through an adhesive or a tackifier on the write-once recording layer mentioned above or a barrier layer mentioned below. As far as a film made from a transparent material is used, there is no particular restriction on the cover layer used in the invention. However, polycarbonates; acrylic resins such as polymethyl methacrylate; vinyl chloride resins such as polyvinylchloride and vinyl chloride copolymers; epoxy resins; amorphous polyolefins; polyester; and cellulose triacetate can be preferably used. Among these, polycarbonate or cellulose triacetate can be preferably used.

“Transparent” means to be 80 percent or more in the transmittance to light used for recording and reproducing.

In the cover layer, as far as the effect of the invention is not disturbed, various kinds of additives can be included. For example, the cover layer may include a UV absorbent that cuts light whose wavelength is 400 nm or less and/or a dye that cuts light whose wavelength is 500 nm or more.

Furthermore, as the physical properties of a surface of the cover layer, the surface roughness is preferably 5 nm or less in both the two-dimensional roughness parameter and the three-dimensional roughness parameter.

From a viewpoint of the collecting power of light used in recording and reproducing, the birefringence of the cover layer is preferably 10 nm or less.

A thickness of the cover layer is appropriately provided with a wavelength of the laser light irradiated for recording and reproducing and the NA. However, in the invention, it is in the range of 0.01 to 0.5 mm, and more preferably in the range of 0.05 to 0.12 mm.

A total thickness of a layer that is made of the cover layer and a layer of an adhesive agent or a tackifier is preferably in the range of 0.09 to 0.11 mm, and more preferably in the range of 0.095 to 0.105 mm.

On the light incidence surface of the cover layer, in order to inhibit the light incidence surface from being flawed while an optical information recording medium is manufactured, a protective layer (a hard coat layer) may be disposed.

As the adhesive that is used to bond the cover layer, for example, a UV curable resin, EB curable resin and a thermosetting resin can be preferably used, and particularly preferably the UV curable resin can be used.

In the case of the UV curable resin being used as the adhesive, the UV curable resin as is or a coating solution prepared by dissolving the UV curable resin in an adequate solvent such as methyl ethyl ketone and ethyl acetate may be supplied from a dispenser on a surface of a barrier layer. In order to inhibit the manufactured optical information recording medium from warping, the UV curable resin constituting the adhesive layer preferably has a small curable contraction rate. As an example of such UV curable resin, UV curable resins such as trade name SD-640, manufactured by Dainippon Ink and Chemicals, Incorporated can be cited.

It is preferable that, for example, a predetermined amount of the adhesive is coated on a bonded surface made of a barrier layer, thereon a cover layer is disposed, followed by spreading by means of spin coating the adhesive evenly between the bonded layer and the cover layer, furthermore followed by curable the adhesive.

A thickness of the adhesive layer made of such adhesive is preferably in the range of 0.1 to 100 μm, more preferably in the range of 0.5 to 50 μm, and further more preferably in the range of 10 to 30 μm.

As the tackifier used to bond the cover layer, an acrylic, a rubber base and a silicon base tackifier can be used. However, from viewpoints of the transparency and the durability, the acrylic tackifiers are preferable. As such acrylic tackifiers, ones in which with 2-ethylhexyl acrylate or n-butyl acrylate as a main component thereof, in order to increase the cohesive force, a short chained alkyl acrylate or methacrylate such as methyl acrylate, ethyl acrylate and methyl methacrylate, and acrylic acid, methacrylic acid, acrylamide derivative, maleic acid, hydroxylethyl acrylate and glycidyl acrylate all of which can work as a crosslinking point with a cross-linking agent are copolymerized can be preferably used. By properly regulating a blending ratio and the kinds of the main component, the short-chained component and the component to add the cross-linking point, the glass transition temperature (Tg) and cross-linking density can be varied.

As the cross-linking agent used together with the tackifier, for example, isocyanate base cross-linking agents can be cited. Examples of such isocyanate base cross-linking agents include isocyanates such as trilene diisocyanate, 4,4′-diphenylmethane diisocyanate, hexamethylene diisocianate, xylylene diisocyanate, naphthylene-1,5-diisocyanate, o-toluidine isocyanate, isohorone diisocyanate and triphenylmethane triisocyanate; or products of the isocyanates and polyalcohols; or polyisocyanates produced by the condensation of the isocyanates. Examples of commercially available products of the isocyanates include trade names: Coronate L, Coronate HL, Coronate 2030, Coronate 2031, Millionate MR and Millionate HTL manufactured by Nippon Polyurethane Industry Co. Ltd.; trade names: Takenate D-102, Takenate D-10N, Takenate D-200 and Takenate D-202 manufactured by Takeda Chemical Industries Co., Ltd.; and trade names: Desmodule L, Desmodule I L, Desmodule N and Desmodule HL manufactured by Sumitomo Bayer Co., Ltd.

The tackifier, after a predetermined amount thereof is coated uniformly on the bonded surface made of the barrier layer and thereon a cover layer is disposed, may be cured, or, after a predetermined amount of the tackifier is beforehand coated on one surface of the cover layer to form a tackifier coated film and the coated film is laminated to the bonded surface, may be cured.

Furthermore, as the cover layer, a commercially available adhesive film on which a tackifier layer is disposed beforehand may be used.

A thickness of the tackifier layer made of the tackifier is preferably in the range of 0.1 to 100 μm, more preferably in the range of 0.5 to 50 μm, and further more preferably in the range of 10 to 30 μm.

### [Other Layers According to the Aspect (1)]

The optical information recording medium according to the preferable aspect (1) may have, as far as the effect of the invention is not damaged, in addition to the indispensable layers mentioned above, other optional layers. As the optional layers, for example, a label layer having a desired image formed on the reverse side of the substrate (the opposite side to the side where the write-once recording layer is formed), a label layer containing a desired image, a light reflective layer (described later) disposed between the substrate and the write-once recording layer, a barrier layer (described later) disposed between the write-once recording layer and the cover layer, and an interface layer disposed between the light reflective layer and the write-once recording layer can be cited. The label layer is formed by using UV curing resins, thermosetting resins, and thermal dry resins.

All of the indispensable layers as well as the optional layers can be a singular layer or may have a multi-layered structure.

### [Light Reflective Layer According to the Aspect (1)]

In the invention, in order to increase the reflectance to the laser light or to impart a function of improving the recording and reproducing properties, a light reflective layer is preferably disposed between the substrate and the write-once recording layer.

The light reflective layer can be formed on a substrate by vacuum evaporation, sputtering or ion plating a light reflective material having high reflectance to the laser light.

A layer thickness of the light reflective layer is generally in the range of 10 to 300 nm and preferably in the range of 50 to 200 nm.

In addition to this, the reflectance is preferably 70 percent or more.

Examples of the light reflective materials high in the reflectance include metals and metalloids such as Mg, Se, Y, Ti, Zr, Hf, V, Nb, Ta, Cr, Mo, W, Mn, Re, Fe, Co, Ni, Ru, Rh, Pd, Ir, Pt, Cu, Ag, Au, Zn, Cd, Al, Ga, In, Si, Ge, Te, Pb, Po, Sn and Bi, or stainless steel. The light reflective materials may be used singularly, or in combinations of two or more kinds thereof, or as alloys thereof also can be used. Among these, Cr, Ni, Pt, Cu, Ag, Au, Al and stainless steel are preferable. Particularly preferably, Au, Ag, Al or the alloys thereof can be used, and most preferably, Au, Ag or alloys thereof can be used.

### [Formation of Barrier Layer (Intermediate Layer)]

In the invention, it is preferable to form a barrier layer between the write-once recording layer and the cover layer.

The barrier layer is disposed in order to increase the storage stability of the write-once recording layer, to increase the adhesiveness between the write-once recording layer and the cover layer, to control the reflectance, and to control the thermal conductivity.

There is no restriction on materials used for the barrier layer, as far as these are materials that can transmit light that is used for recording and reproducing and also can exhibit the above functions. For example, in general, it is preferably a material low in the permeability of gas and water and dielectrics.

Specifically, materials made of nitrides, oxides, carbides and sulfides of Zn, Si, Ti, Te, Sn, Mo and Ge are preferable. Among these, ZnS, MoO₂, GeO₂, TeO, sio₂, TiO₂, ZnO, ZnS—SiO₂, SnO₂ and ZnO—Ga₂O₃ are preferable, and ZnS—SiO₂, SnO₂ and ZnO—Ga₂O₃ are more preferable.

The barrier layer can be formed also by a vacuum film formation method such as vacuum evaporation, DC sputtering, RF sputtering or ion plating. Among these, it is more preferable to use the sputtering method, and the RF sputtering can be further more preferably used.

A thickness of the barrier layer according to the invention is preferably in the range of 1 to 200 nm, more preferably in the range of 2 to 100 nm, and further more preferably in the range of 3 to 50 nm.

Hereinafter, the optical information-recording medium of favorable aspect (2) will be described. The optical information-recording medium of aspect (2) is an optical information-recording medium having a laminated layer structure, and typical examples of the layer structures are as follows:

(1) First layer structure having a write-once recording layer, a light-reflective layer, and an adhesive layer formed in that order on a substrate and additionally a protective substrate formed on the adhesive layer.

(2) Second layer structure having a write-once recording layer, a light-reflective layer, a protective layer, and an adhesive layer formed in that order on a substrate and additionally a protective substrate formed on the adhesive layer.

(3) Third layer structure having a write-once recording layer, a light-reflective layer, a protective layer, an adhesive layer, and a protective layer formed in that order on a substrate, and additionally a protective substrate formed on the protective layer.

(4) Fourth layer structure having a write-once recording layer, a light-reflective layer, a protective layer, an adhesive layer, a protective layer, and a light-reflective layer formed in that order on a substrate and additionally a protective substrate formed on the light-reflective layer.

(5) Fifth layer structure having a write-once recording layer, a light-reflective layer, an adhesive layer, and a light-reflective layer formed in that order on a substrate and additionally a protective substrate formed on the light-reflective layer.

The layer structures (1) to (5) are mere exemplifications, and the layer structure is not limited to those described above, and some of the layers may be changed in order or may be eliminated. The write-once recording layer may be formed additionally on the protective substrate-sided surface, and in such a case, an optical information-recording medium allowing recording and reproduction from both faces is obtained. Further, each layer may be a single layer or may contain multiple layers. The optical information-recording medium according to the invention will be described below, by taking a media having a write-once recording layer, a light-reflective layer, an adhesive layer, and a protective substrate formed in that order on a substrate as an example.

### [Substrate According to the Aspect (2)]

A pre-groove (guide groove) in the shape having a track pitch, a groove width (half value width), a groove depth, and a wobble amplitude all in the following ranges is formed essentially on the substrate of favorable aspect (2). The pre-groove, which is formed for giving the substrate with a recording density higher than that of CD-R or DVD-R is particularly favorable, for example when the optical information-recording medium according to the invention is used as a medium compatible with blue purple laser.

The pre-groove track pitch is preferably in the range of 200 to 600 nm, and the upper limit is preferably 500 nm or less, more preferably, 450 nm or less, and still more preferably 430 nm or less. The lower limit is preferably 300 nm or more, more preferably 330 nm or more, and still more preferably 370 nm or more. A track pitch of less than 200 nm may make it difficult to form the pre-groove accurately, causing a problem of crosstalk, while that of more than 600 nm may cause a problem of deterioration in recording density.

The pre-groove width (half value width) is preferably in the range of 50 to 300 nm, and the upper limit is preferably 250 nm or less, more preferably 200 nm or less, and still more preferably 180 nm or less. The lower limit is preferably 100 nm or more, more preferably 120 nm or more, and still more preferably 140 nm or more. A pre-groove width of less than 50 nm may lead to insufficient transfer of the groove during molding, and increase in the error rate during recording, while that of more than 300 nm to broading the pit formed during recording, causing a problem of crosstalk, and insufficient modulation.

The pre-groove depth is preferably in the range of 30 to 200 nm, and the upper limit is preferably 170 nm or less, more preferably 140 nm or less, and still more preferably 120 nm or less. The lower limit is preferably 40 nm or more, more preferably 50 nm or more, and still more preferably 60 nm or more. A pre-groove depth of less than 30 nm may lead to insufficient recording modulation, while that of more than 200 nm to drastic decrease in reflectance.

Any one of various materials used for the substrates in conventional optical information-recording media may be used, as it is properly selected, in production of the substrate favorable for use in aspect (2), and typical examples and favorable examples thereof are the same as those described for the substrate in aspect (1). The thickness of the substrate should be in the range of 0.1 to 1.0 mm, preferably in the range of 0.2 to 0.8 mm, and more preferably in the range of 0.3 to 0.7 mm.

An undercoat layer is preferably formed on the write-once recording layer-sided surface of the substrate for improvement in planarity and adhesive strength, and typical and favorable examples of the materials, coating methods and layer thickness of the undercoat layer are the same as those described for the undercoat layer of aspect (1).

[Write-Once Recording Layer according to the Aspect (2)]

Details of the write-once recording layer of aspect (2) are the same as those of the write-once recording layer of aspect (1).

[Light-Reflective Layer according to the Aspect (2)]

In favorable aspect (2), a light-reflective layer is occasionally formed on the write-once recording layer for improvement in reflectance to laser beam and record reproduction properties. Details of the light-reflective layer of aspect (2) are the same as those of the light-reflective layer of aspect (1).

### [Adhesive Layer According to the Aspect (2)]

The adhesive layer of favorable aspect (2) is any layer that is formed for improving the adhesion between the light-reflective layer and the protective substrate. The material for the adhesive layer is preferably a curable photocurable resin, and in particular, a curable photocurable resin having low curable shrinkage for prevention of disk warpage.

Examples of the photocurable resins include UV-curable resins (LV-curable adhesives) such as trade names: SD-640 and SD-347; manufactured by Dainippon Ink and Chemicals, Inc., and the like. The thickness of the adhesive layer is preferably in the range of 1 to 1000 μm for providing the layer with a sufficient elasticity.

### [Protective Substrate According to the Aspect (2)]

The same material as that for the substrate described above in the same shape can be used as the protective substrate of favorable aspect (2) (dummy substrate). The thickness of the protective substrate should be in the range of 0.1 to 1.0 mm, preferably in the range of 0.2 to 0.8 mm, and still more preferably in the range of 0.3 to 0.7 mm.

### [Protective Layer According to the Aspect (2)]

The optical information-recording medium of favorable aspect (2) may have a protective layer for physical and chemical protection of the light-reflective layer, write-once recording layer, or the like, depending on its layer structure. Examples of the materials for the protective layer include inorganic materials such as ZnS, ZnS—SiO₂, SiO, SiO₂, MgF₂, SnO₂, and Si₃ N₄; and organic materials such as thermoplastic resin, thermosetting resin, and UV-curable resin. The protective layer can be prepared, for example, by bonding a film prepared by extrusion of a plastic resin with an adhesive onto a light-reflective layer. Alternatively, it may be formed by an other method such as vacuum deposition, sputtering, or coating.

The protective layer, when made of a thermoplastic resin or thermosetting resin, may be formed by preparing a coating solution by dissolving the resin in a suitable solvent and coating and drying the coating solution. When a UV-curable resin is use, the protective layer may be formed by preparing a coating solution by dissolving it in a suitable solvent, coating the coating solution, and hardening the coated film by UV irradiation. Various additives such as antistatic agent, antioxidant, and UV absorbent may be added additionally to such a coating solution, according to its application. The thickness of the protective layer is generally in the range of 0.1 μm to 1 mm.

### [Other Layers According to the Aspect (2)]

In the optical information recording medium of the favorable aspect (2), as far as the effect of the invention is not disturbed, other optional layers can be included in addition to the layers above. Details of the other optional layers are the same as those of the other layers of aspect (1).

[2] Optical information-recording method:

The optical information-recording method according to the invention is performed by using the optical information-recording medium in favorable aspect (1) or (2), for example, as follows: First, a beam for recording such as semiconductor laser is irradiated on the optical information-recording medium, while rotating at a constant linear velocity (0.5 to 10 m/sec) or a constant angular velocity, from the cover layer side in the case of aspect (1) or from the substrate side in the case of aspect (2). It appears that the information is recorded, as the photoirradiation raises the temperature in local regions of the recording layer because of absorption of the light, resulting in change in physical or chemical properties (for example, pit formation) thereof.

In the invention, a semiconductor laser light having an oscillation wavelength ranging from 390 to 440 nm (preferably from 400 to 410 nm) is used as the recording light. Examples of preferable light sources include a bluish-purple semiconductor laser having an oscillation wavelength ranging from 390 to 415 nm and a bluish-purple SHG laser having a central oscillation wavelength of 425 nm obtained by halving the wavelength of an infrared semiconductor laser, whose central oscillation wavelength is 850 nm, using a optical waveguide element. The bluish-purple semiconductor laser having an oscillation wavelength ranging from 390 to 415 nm is particularly preferable in terms of recording density. Recorded information can be played back by irradiating the medium with the semiconductor laser from the side of covering layer in aspect (1) and from the side of substrate in aspect (2), while rotating the medium at the same constant linear velocity as mentioned above and detecting the reflected light.

Use of a recording layer containing a dye having two or more independent dye moieties in the molecule that are bound to each other without a conjugated bond enables high-density recording and reproduction of information by irradiation of a laser beam having a wavelength of 440 nm or less and makes its optical storability favorable. It is probably because association of the dye per unit volume is reduced.

At least one of the following first to eighth aspects is preferably applied to the optical information-recording medium according to the invention.

(1) A first aspect wherein the dye has a structure represented by the following Formula (1).

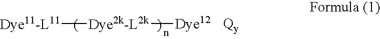

(In Formula (I), Dye¹¹, Dye¹², and Dye^{2k} each represent a dye moiety; L¹¹ and L^{2k} each represent a bivalent connecting group that does not form a π-conjugated bond with the dye moiety bound thereto; n is an integer of 0 or more and 10 or less; k is an integer of 0 to n; when n is an integer of 2 or more, multiple groups Dye^{2K} may be the same as or different from each other; when n is an integer of 2 or more, multiple groups L^{2K} may be the same as or different from each other; Q represents an ion for neutralizing the electric charge; and y is the number of the ions need for neutralizing the electric charge).

The dye, which has the structure represented by Formula (I), reduces association of the dye per unit volume and improves light fastness.

(2) A second aspect wherein the dye moiety is an oxonol dye moiety.

Multimer dyes are generally hardly soluble in solvents, however, by being an oxonol dye moiety, the dye is allowed to be more soluble in fluorinated alcohols.

(3) A third aspect wherein the dye is represented by the following Formula (2-1), (2-2), (2-3), (2-4) or (2-5).

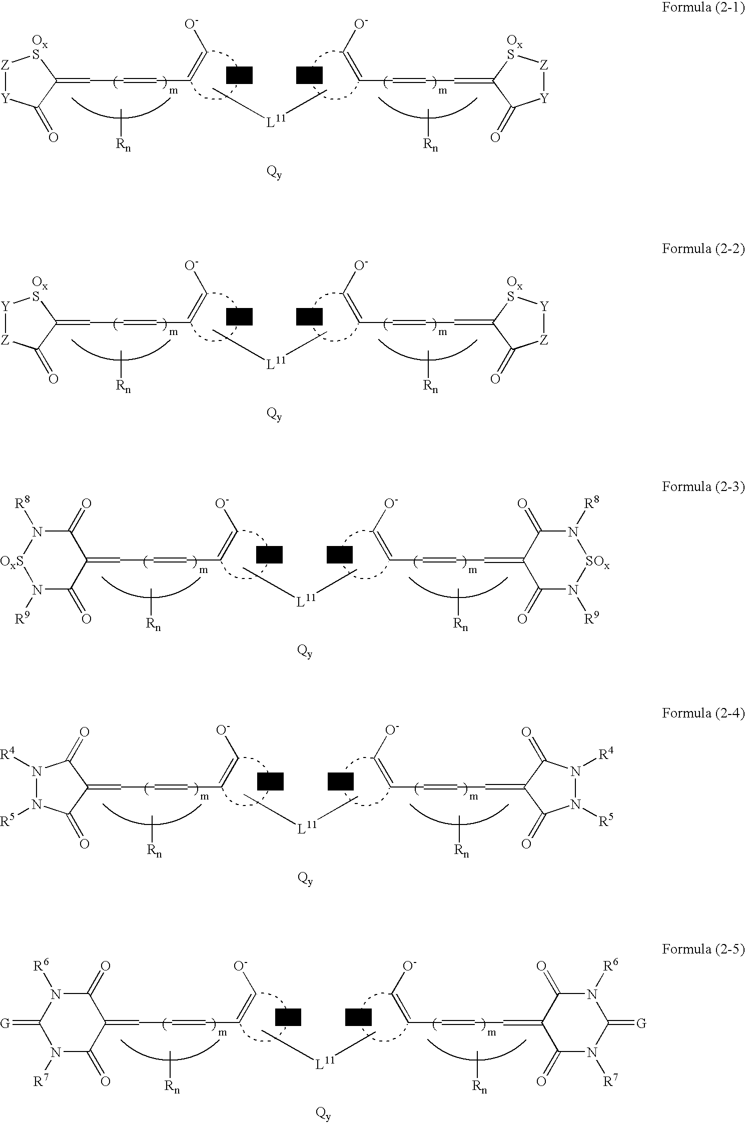

(In Formulae (2-1), (2-2), (2-3), (2-4), and (2-5) above, R represents a substituent group on the methine carbon; m is an integer of 0 to 1; n is an integer of 0 to 2 m+1; when n is an integer of 2 or more, multiple groups R may be the same as or different from each other, or may bind to each other forming a ring; Za⁵ and Za⁶ each represent an atom group forming an acidic nucleus; The definitions of L¹¹, Q, and y are the same as L¹¹, Q, and y in Formula (1); Y represents any of —O—, —NR¹— and —CR²R³—; R¹ to R⁹ each independently represents a hydrogen atom or a substituent group; Z represents a substituted or unsubstituted alkylene group; and x is 1 or 2. G represents an oxygen atom or sulfur atom, preferably an oxygen atom).

The dyes represented by Formula (2-1), (2-2), (2-3), (2-4), and (2-5) are superior in degradability, allowing favorable recording.

(4) A fourth aspect wherein m in Formula (2-1), (2-2), (2-3), (2-4), or (2-5) is 0. When m is 0, the dye has a photostability better than that of the dye wherein m is 1 or more. It is probably because the conjugate chains are more intermingled spatially when m is 0, prohibiting penetration of singlet oxygen.

(5) A fifth aspect wherein the dye is an oxonol dye represented by the following Formula (5-1), (5-2), (5-3), (5-4) or (5-5).

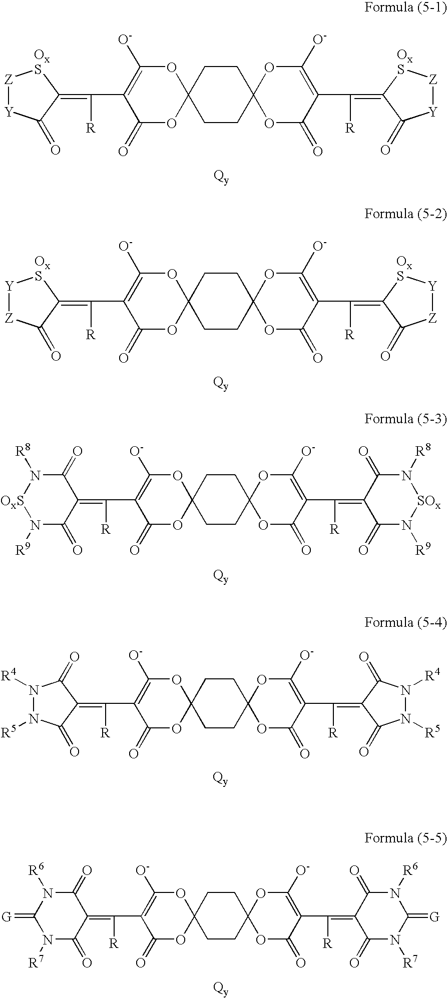

(In Formulae (5-1), (5-2), (5-3), (5-4), and (5-5) above, R, Z, Y, Q, and y are the same as R, Z, Y, Q, and y in Formulae (2-1) to (2-5); R¹ to R⁹ each independently represent a hydrogen atom or a substituent group; and G represents an oxygen atom or sulfur atom).

The dye represented by Formula (5-1), (5-2), (5-3), (5-4), or (5-5) is superior in degradability, allowing favorable recording.

(6) A sixth aspect wherein a light-reflective layer made of metal is formed in addition to the recording layer. Presence of the light-reflective layer is effective in improving the reflectance during information reproduction.

(7) A seventh aspect wherein a protective layer is formed in addition to the recording layer. Presence of the protective layer is effective in protecting various layers.

(8) A eighth aspect wherein the substrate is a transparent disk-shaped substrate with a pre-groove having a track pitch of 50 to 600 nm formed on its surface, and the recording layer is formed on the pre-groove-sided surface of the substrate. In such a configuration, it is possible to perform high-density recording of information more reliably.

The invention also provides an information-recording method of recording information by irradiation of a laser beam having a wavelength of 440 nm or less onto the optical information-recording medium according to the invention described above. The information-recording method according to the invention allows high-density recording and reproduction of information favorably by using the optical information-recording medium according to the invention described above.

### EXAMPLES

Hereinafter, exemplary synthesis methods of some of the compounds in Examples will be described. Other compounds (S-2 to S-4, S-6 to S-22, and S-24 to S-27) can be prepared similarly.

### Synthesis Example 1

Synthesis of compound (S-1) above: the compound was synthesized according to the following scheme (A).

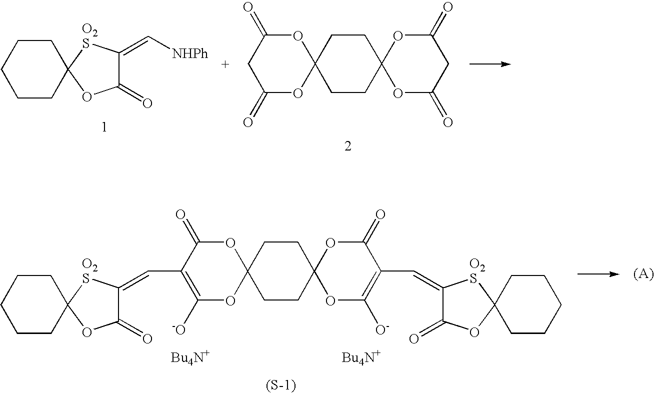

2.84 g of “compound 2” was dissolved in 50 ml of N,N′-dimethylformamide, then the solution was cooled to 0° C., while stirring the solution, 8.34 ml of triethylamine was added and then 5.86 g of “compound 1” was added thereto. After reacting at 0° C. for 4 hours, 8.00 g of tetrabutylammonium bromide was added and followed by stirring for 1 hour. The reaction solution was poured into 300 ml of water, and filtrated to obtain white crystals. The crystals obtained were washed with ethyl acetate, to yield 6.06 g of a compound (S-1).

The structure was determined by NMR. ¹H NMR (DMSO-d⁶): d: 0.95 (t, 24H), 1.31 (m, 16H), 1.4 to 1.9 (m, 20H), 2.05 (s, 8H), 3.15 (t, 16H), and 7.89 (s, 2H).

### Synthesis Example 2

Synthesis of compound (S-5) above: the compound was synthesized according to the following scheme (B).

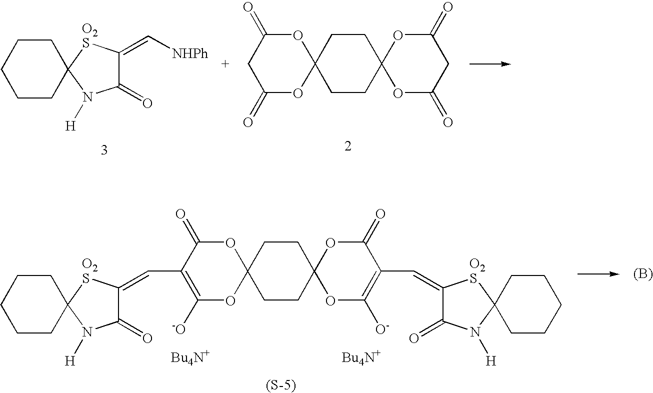

2.84 g of “compound 2” was dissolved into 50 ml of N,N′-dimethylformamide, then the solution was cooled to 0° C., while stirring the solution, 8.34 ml of triethylamine was added and then 6.12 g of “compound 3” was added thereto. After reacting at 0° C. for 4 hours, 7.00 g of tetrabutylammonium bromide was added and followed by stirring for 1 hour. The reaction solution was poured into 300 ml of water, and filtrated to obtain white crystals. The crystals obtained were washed with ethyl acetate-methanol, to yield 8.00 g of a compound (S-5).

The structure was determined by NMR. ¹H NMR (DMSO-d⁶): d: 0.95 (t, 24H), 1.31 (m, 16H), 1.5 to 2.5 (m, 28H), 3.15 (t, 16H), and 7.92 (s, 2H).

### Synthesis Example 3

Synthesis of the compound S-23 above: the compound was synthesized according to the following schemes (C) to (D).

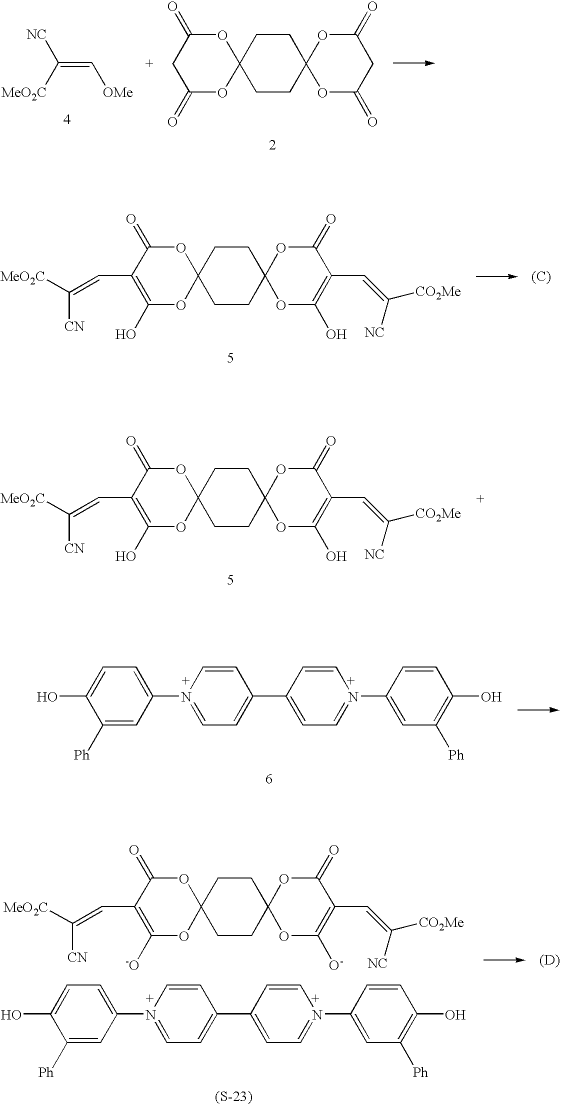

0.29 g of “compound 4” and 0.29 g of “compound 2” were added into 5 ml of ethanol, while stirring the solution, 0.57 ml of triethylamine was added thereto. After reacting at room temperature for 4 hours, the generated crystals were filtrated to yield 0.24 g of a “compound 5”.

0.24 g of “compound 5” was added into 2.5 ml of dimethylformamide, and then 0.27 g of “compound 6” was added thereto to react at 50° C. for 1 hour. After that, the solution was cooled to room temperature and then 40 ml of methanol was added thereto to generate crystals. The generated crystals were filtrated to yield 0.31 g of a compound (S-23).

The structure was determined by NMR. ¹H NMR (DMSO-d⁶): d: 2.0 (s, 8H), 3.65 (s, 6H), 7.2 to 7.8 (m, 14H), 7.9 (s, 2H), 8.15 (s, 2H), 9.0 (d, 4H), 9.7 (d, 4H), and 10.75 (s, 2H).

### [Synthesis of Comparative Compound (H-1)]

The compound was synthesized according to the following scheme (E).

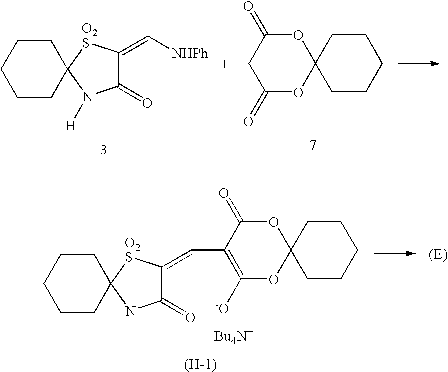

4.15 g of “compound 3” and 2.50 g of “compound 7” were dissolved in 40 ml of acetonitrile followed by adding 1.28 ml of acetic anhydride dropwise and then 1.90 ml of triethylamine dropwise, then the solution was refluxed with stirring. After reacting for 2 hours, 7.00 g of tetrabutylammonium bromide was added, and the mixture was stirred for 1 hour. 300 ml of ethyl acetate was added to the reaction solution, and the solution was filtrated to give white crystals. The generated crystals were washed with ethyl acetate to yield 5.33 g of a compound (H-1).

The structure was determined by NMR. ¹H NMR (CDCl₃): d: 0.95 (t, 12H), 1.31 (m, 16H), 1.55 to 2.7 (m, 20H), 3.22 (t, 8H), and 8.21 (s, 2H).

### Examples 1 to 4

### Preparation of Optical Information-Recording Medium

### (Preparation of Substrate)

A polycarbonate resin substrate having a thickness of 1.1 mm, an external diameter of 120 mm, and an internal diameter of 15 mm and having a spiral pre-groove (track pitch: 320 nm, groove width: on-groove width 120 nm, groove depth: 35 nm, groove inclination angle: 65°, wobble amplitude: 20 nm) was prepared by injection molding. Mastering of the stamper used in injection molding was performed by laser cutting (351 nm).

### (Formation of Light Reflective Layer)

On the substrate, by use of trade name: Cube, manufactured by Unaxis, in an atmosphere of Ar, by means of DC sputtering, an APC light reflective layer (Ag: 98.1 mass percent, Pd: 0.9 mass percent, and Cu: 1.0 mass percent) as a vacuum deposition layer with a film thickness of 100 nm was formed. The film thickness of the light reflective layer was controlled by a sputter time.

### (Formation of Write-Once Recording Layer)

Two grams of each compound, (S-1), (S-4), (S-5) and (S-23) in the Table 1 was added to 100 ml of 2,2,3,3-tetrafluoropropanol to dissolve, and thereby a dye containing coating solution was prepared. On the light reflective layer, the prepared dye containing coating solution was coated by means of the spin coat method, with the number of revolutions varying in the range of 300 to 4000 rpm, under conditions of 23 degrees centigrade and 50 percent RH. Then, it was stored for 1 hr at 23 degrees centigrade and 50 percent RH, and a write-once recording layer (with a thickness on the groove of 120 nm and a thickness on the land of 170 nm) was formed.

After the write-once recording layer was formed, in a clean oven, annealing treatment was carried out. The substrates were supported on a vertical stack pole distanced with spacers and the annealing treatment was applied at 80 degrees centigrade for 1 hr.

### (Formation of Barrier Layer)

After that, on the write-once recording layer, by use of trade name: Cube, manufactured by Unaxis, in an atmosphere of Ar, by means of RF sputtering, a barrier layer that was 5 nm in thickness and made of ZnO—Ga₂O₃ (ZnO:Ga₂O₃=7:3 (by mass ratio)) was formed.

### (Bonding of Cover Layer)

As a cover layer, with a polycarbonate film (Trade name: Teijin Pure Ace, thickness: 80 μm) having an internal diameter of 15 mm, an external diameter of 120 mm, and one surface on which a tackifier was used, a sum total of thicknesses of the tackifier layer and the polycarbonate film was controlled so as to be 100 μm.

Then, after the cover layer was disposed on the barrier layer so that the barrier layer and the tackifier layer may come into contact, the cover layer was pressure bonded by use of a pressing member to bond.

### Comparative Examples 1 to 4

Disks were prepared in just the same manner to Examples 1 to 4, except that the compound (S-1), (S-4), (S-5), and (S-23) were replaced respectively with the comparative compounds (A) to (D) represented by the following Chemical Formulae.

Comparative compound A (typical example (b) described in JP-A No. 11-58758)

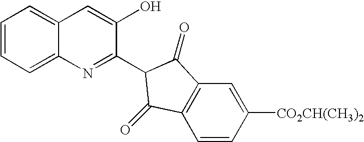

Comparative compound B (typical example (c) described in JP-A No. 11-58758)

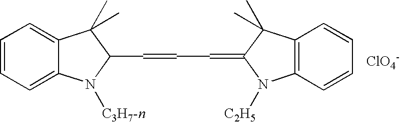

Comparative compound C (typical example (32) described in JP-A No. 2001-71638)

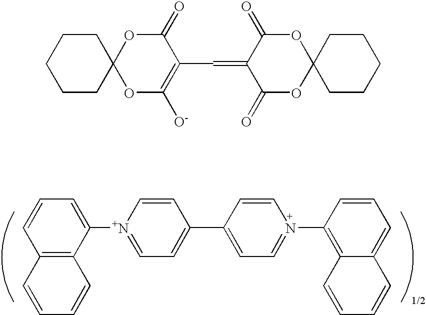

Comparative compound D (typical example (34) described in JP-A No. 2001-71638)

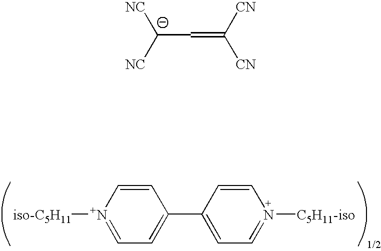

The optical information-recording medium of Examples 1 to 4 and Comparative Examples 1 to 4 were thus prepared.

### <Evaluation of Optical Information-Recording Medium>

Evaluation of C/N Ratio (Carrier Wave to Noise Ratio)

The C/N ratio (after recording) of each of the optical information-recording medium prepared was determined by a spectrum analyzer (TR4171, manufactured by Advantest Corporation), when a 0.16-μm signal (2T) is recorded and reproduced in a recording/reproducing inspecting machine carrying a 403-nm laser and a pickup having a NA of 0.85 (Trade name: DDU1000; manufactured by Pulstec Industrial Co. Ltd.,) under the conditions of a clock frequency of 66 MHz and a linear velocity of 5.28 m/s. Results are shown in Table 3. The recordation was carried out on the groove for the evaluation. The recording output then was 5.2 mW, and the reproduction power was 0.3 mW.

### Examples 5 to 8

### Preparation of Optical Information-Recording Medium

### (Preparation of Substrate)

A injection molded substrate made of polycarbonate resin having a thickness of 0.6 mm, an external diameter of 120 mm, and an internal diameter of 15 mm, and a spiral pre-groove (track pitch: 400 nm, groove width: 170 nm, groove depth: 100 nm, groove angle: 65°, wobble amplitude: 20 nm) was prepared. Mastering of the stamper used in injection molding was conducted by using a laser cutting (351 nm).

### (Formation of Write-Once Recording Layer)

Two grams of each compound, (S-1), (S-4), (S-5) and (S-23) in the Table 1 was added to 100 ml of 2,2,3,3-tetrafluoropropanol to dissolve, and thereby a dye containing coating solution was prepared. On the substrate, the prepared dye containing coating solution was coated by means of the spin coat method, with the number of revolutions varying in the range of 300 to 4000 rpm, under conditions of 23 degrees centigrade and 50 percent RH. Then, it was stored for 1 hr at 23 degrees centigrade and 50 percent RH, and a write-once recording layer (with a thickness on the groove of 120 nm and a thickness on the land of 170 nm) was formed.

After the write-once recording layer was formed, in a clean oven, annealing treatment was carried out. The substrates were supported on a vertical stack pole distanced with spacers and the annealing treatment was applied at 80 degrees centigrade for 1 hr.

### (Formation of Light Reflective Layer)

On the write-once recording layer, by use of trade name: Cube, manufactured by Unaxis, in an atmosphere of Ar, by means of DC sputtering, an APC light reflective layer (Ag: 98.1 mass percent, Pd: 0.9 mass percent, and Cu: 1.0 mass percent) as a vacuum deposition layer with a film thickness of 100 nm was formed. The film thickness of the light reflective layer was controlled by a sputter time.

### (Bonding of Protective Substrate)

A ultraviolet-curable resin (SD640, manufactured by Dainippon Ink and Chemicals) was coated on the light-reflective layer by spin coating, then a protective substrate made of polycarbonate (the same as the substrate above except no pre-groove was formed) is bonded thereon, and cured by ultraviolet ray irradiation. The thickness of the adhesive layer of the ultraviolet-curable resin in the optical information-recording medium prepared was 25 μm.

### Comparative Examples 5 to 8

Disks were prepared in just the same manner to Examples 5 to 8, except that the compound (S-1), (S-4), (S-5), and (S-23) were replaced respectively with the comparative compounds (A) to (D) represented by the above Chemical Formulae.

Thus, optical information-recording medium of Examples 5 to 8 and Comparative Examples 5 to 8 were prepared.

### <Evaluation of Optical Information-Recording Medium>

Evaluation of C/N Ratio (Carrier Wave to Noise Ratio):

The C/N ratio (after recording) of each of the optical information-recording media prepared was determined by using a spectrum analyzer (TR4171, manufactured by Advantest Corporation), while a 0.204-μm signal (2T) is recorded and reproduced in a recording/reproducing inspecting machine carrying a 405-nm laser and a pickup having a NA of 0.65 (DDU1000, manufactured by Pulstec Industrial) under the condition of a clock frequency of 64.8 MHz and a linear velocity of 6.61 m/s. Results are shown in Table 3. The recordation was kept on the groove in the evaluation by using the optical information-recording method according to the invention. The recording output was 12 mW and the reproduction power was 0.5 mW then. Results are shown in Table 3. The C/N ratio of 25 dB or more (after recording) indicates that the reproduced signal intensity is sufficiently large and the recording properties are favorable.

TABLE 3

| | Dye compound | C/N (dB) |
|---|---|---|
| Example 1 | (S-1) | 41 |
| Example 2 | (S-4) | 44 |
| Example 3 | (S-5) | 45 |
| Example 4 | (S-23) | 45 |
| Example 5 | (S-1) | 41 |
| Example 6 | (S-4) | 42 |
| Example 7 | (S-5) | 44 |
| Example 8 | (S-23) | 45 |
| Comparative Example 1 | (A) | 18 |
| Comparative Example 2 | (B) | 10 |
| Comparative Example 3 | (C) | 40 |
| Comparative Example 4 | (D) | 38 |
| Comparative Example 5 | (A) | 16 |
| Comparative Example 6 | (B) | 10 |
| Comparative Example 7 | (C) | 30 |
| Comparative Example 8 | (D) | 28 |

The results in Table 3 above showed that optical information-recording media having a recording layer containing a dye having two or more independent dye moieties in the molecule, that are bound to each other without a conjugated bond (Examples 1 to 8), were superior in reproduction signal intensity to the optical information-recording media obtained in Comparative Examples 1 to 8. In addition, the optical information-recording media (I) to (IV) were prepared in the same manner as Example 5 using compounds (S-28), (S-29), (S-30) and (S-31), respectively. Further, it is clear that these optical-information-recording media were also superior in reproduction signal intensity.

### <Effect of Optical Storability>

[Preparation of Glass Substrate]

Each of the compounds (S-1) and (S-5) in Table 1, and comparative compounds (H-1) and (H-2) was added in an amount of 20 mg to 1 ml of 2,2,3,3-tetrafluoropropanol to dissolve, and thereby a dye containing coating solution was prepared. On the glass substrate, the prepared dye containing coating solution was coated by means of the spin coat method, with the number of revolutions varying in the range of 300 to 4000 rpm, under conditions of 23° C. and 50% RH. The compound (H-2) was the compound (1-8) described in JP-A No. 2001-52293, which was prepared according to the method in the Example therein.

### [Evaluation of Light Fastness]

Then, the glass substrate was stored under shading condition at room temperature for one day. After that, the dye-coated glass substrate was disposed on the Merry-Go-Round type light resistance testing machine (custom-manufactured by EAGLE ENGINEERING Inc.), and was light irradiated at a distance of 8 cm from the light source using an xenon lamp (XL-500D-O 500W, manufactured by USHIO DISCHARGE LAMPS) attached a filter (H-A-50, manufactured by HOYA). The absorbance was then determined by using a TV-1600 (trade name: manufactured by SHIMADZU).

The absorbances of compounds (S-1) and (S-5) were compared with those of the comparative compounds (H-1) and (H-2). The changes with time in absorbance according to the above determination are shown in the following Table 4.

TABLE 4

| | | | |
|---|---|---|---|
| H-2 | H-1 | S-1 | S-5 |

| | | | | |
|---|---|---|---|---|
| 0 hour later | 100% | 100% | 100% | 100% |
| 24 hours later | 81.20% | 72.00% | 93.10% | 85.30% |
| 48 hours later | 67.60% | 24.10% | 87.20% | 75.40% |

The results in Table 4 reveal that the compounds (S-1) and (S-5) have an optical storability longer than the comparative compounds (H-1) and (H-2).

With the compound (H-2) as the standard, the remaining dye compounds show comparative relationships, as shown in Table 5, at the end of 48 hours, when the compound (H-1) is compared to the compound (S-1) or (S-5) superior dye in light storability of more than three times is found. This demonstrates the usefulness of the invention.

TABLE 5

| (H-1/H-2) | (H-2/H-2) | (S-1/H-2) | (S-5/H-2) |
|---|---|---|---|
| 0.356 | 1 | 1.29 | 1.12 |

All of the results above indicate that it is possible to obtain an optical information-recording medium favorable in recording properties and storability by using a dye having two or more independent dye moieties in the molecule that are bound to each other without a conjugated bond. Because such advantageous effects can be obtained when using a laser having a wavelength shorter than those of CD-R and DVD-R, a higher density information-recording medium and a recording and reproducing method using the same can be provided.

According to the aspects of the invention, there is provided an optical information-recording medium which favorably allows high-density recording and reproduction of information by irradiation of a laser beam having a wavelength of 440 nm or less and is superior in light storability, and a method of recording information on an optical information-recording medium.

All publications, patent applications, and technical standards mentioned in this description are herein incorporated by reference to the same extent as if each individual publication, patent application, or technical standard was specifically and individually indicated to be incorporated by reference.

1. An optical information-recording medium, comprising a recording layer capable of recording of information by irradiation of a laser beam having a wavelength of 440 nm or less on or above a substrate, the recording layer comprising a dye having two or more independent dye moieties in a molecule that are bound to each other in a manner other than by forming a conjugated bond to the dye moieties.

2. The optical information-recording medium of claim 1, wherein the dye has a structure represented by the following Formula (I): 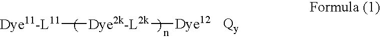
wherein in Formula (I), Dye¹¹, Dye¹², and Dye^{2k} each represent a dye moiety; L¹¹ and L^{2k} each represent a bivalent connecting group that does not form a π-conjugated bond with the dye moieties bound thereto; n is an integer of 0 to 10; k is an integer of 0 to n; when n is an integer of 2 or more, multiple groups Dye^{2K} may be the same as or different from each other; when n is an integer of 2 or more, multiple groups L^{2K} may be the same as or different from each other; Q represents an ion for neutralizing the electric charge; and y is the number of the ions need for neutralizing the electric charge.

3. The optical information-recording medium of claim 1 or 2, wherein the dye moiety is an oxonol dye moiety.

4. The optical information-recording medium of claim 1, wherein the dye is a dye represented by the following Formula (2-1), (2-2), (2-3), (2-4), or (2-5): 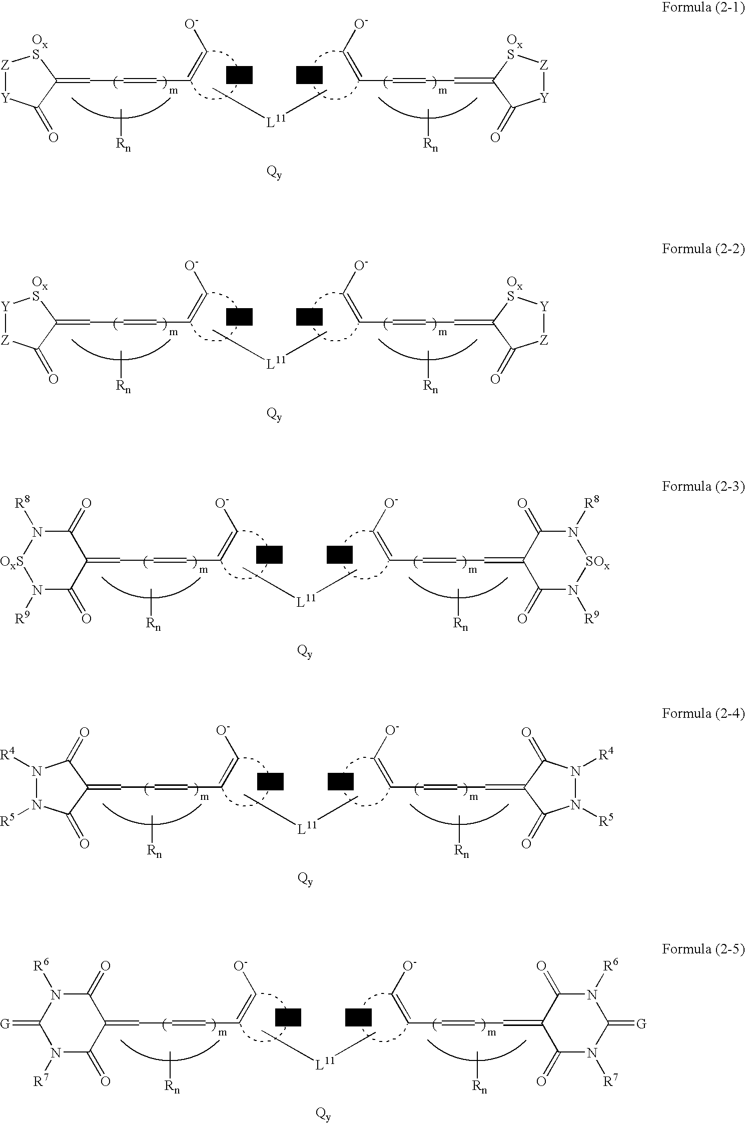
wherein in Formulae (2-1), (2-2), (2-3), (2-4) and (2-5) above, R represents a substituent group on the methine carbon; m is an integer of 0 to 1; n is an integer of 0 to 2m+1; when n is an integer of 2 or more, multiple Rs may be the same as or different from each other, or may bind to each other forming a ring; Za⁵ and Za⁶ each represent an atom group forming an acidic nucleus; L¹¹ each represent a bivalent connecting group that does not form a π-conjugated bond with the dye moieties bound thereto; Q represents an ion for neutralizing the electric charge; and y is the number of the ions need for neutralizing the electric charge; Y represents any of —O—, —NR¹— or —CR²R³—; R¹ to R⁹ each independently represents a hydrogen atom or a substituent group; Z represents a substituted or unsubstituted alkylene group; and x is 1 or 2; G represents an oxygen atom or sulfur atom.

5. The optical information-recording medium of claim 4, wherein m in the Formula (2-1), (2-2), (2-3), (2-4), and (2-5) is 0.

6. The optical information-recording medium of claim 5, wherein the dye is a dye represented by the following Formula (5-1), (5-2), (5-3), (5-4), or (5-5): 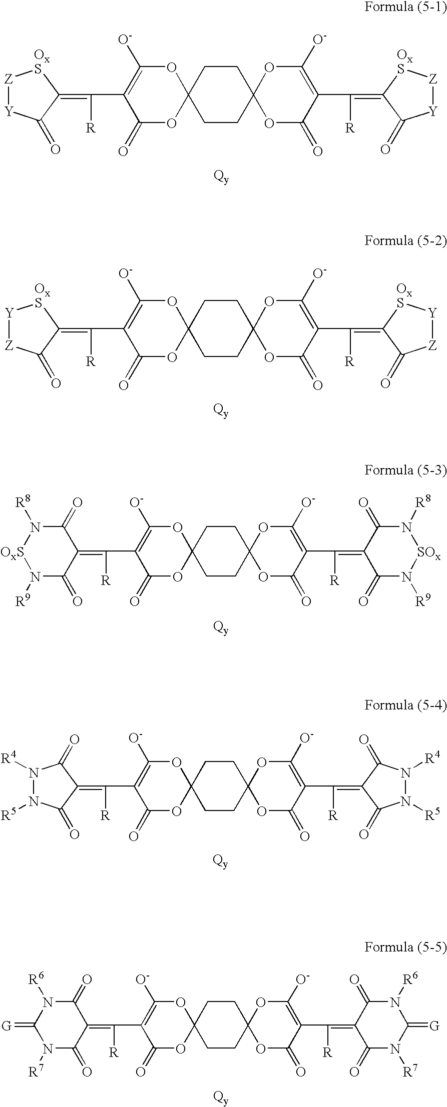
wherein in Formulae (5-1), (5-2), (5-3), (5-4), and (5-5) above, R represents a substituent group on the methine carbon; Q represents an ion for neutralizing the electric charge; y is the number of the ions needed for neutralizing the electric charge; Y is any of —O—, —NR¹— and —CR²R³—; Z represents a substituted or unsubstituted alkylene group; x is 1 or 2; and R¹ to R⁹ each independently represents a hydrogen atom or a substituent group; and G represents an oxygen atom or sulfur atom.

7. The optical information-recording medium of claim 1, further comprising a light-reflective layer made of metal in addition to the recording layer.

8. The optical information-recording medium of claim 1, further comprising a protective layer in addition to the recording layer.

9. The optical information-recording medium of claim 1, wherein the substrate is a transparent disk-shaped substrate with a pre-groove having a track pitch of 50 to 600 nm formed on its surface and the recording layer is formed on the surface of the substrate on the pre-groove-side.

10. A method of recording information, comprising recording information by irradiating a laser beam having a wavelength of 440 nm or less onto an optical information-recording medium having a recording layer on or above a substrate the recording layer comprising a dye having two or more independent dye moieties in a molecule that are bound to each other in a manner other than by forming a conjugated bond to the dye moieties.
